(19) United States
(12) Patent Application Publication
(10) Pub. No.: US 2025/0285130 A1
(43) Pub. Date: Sep. 11, 2025

(54) APPARATUS AND A METHOD FOR THE GENERATION OF UNIQUE SERVICE DATA

(71) Applicant: The Strategic Coach Inc., Toronto (CA)

(72) Inventors: Barbara Sue Smith, Toronto (CA); Daniel J. Sullivan, Toronto (CA)

(73) Assignee: The Strategic Coach Inc., Toronto (CA)

(21) Appl. No.: 18/600,252

(22) Filed: Mar. 8, 2024

(51) Int. Cl. G06Q 30/0202

(52) U.S. Cl. CPC G06Q 30/0202

(57) ABSTRACT

An apparatus for the generation of unique service data is disclosed. The apparatus includes a processor and a memory communicatively connected to the at least a processor. The memory instructs the processor to receive a plurality of user data and a plurality of entity data. The memory instructs the processor to identify one or more user clusters as a function of the user data. The memory instructs the processor to identify one or more entity clusters as a function of the entity data. The processor additionally extracts a keyword set from each of the one or more clusters The memory instructs the processor to generate unique service data as a function of the comparison of the one or more user clusters to the one or more entity clusters using a trained service machine learning model. The memory instructs the processor to display the unique service data using a display device.

### FIELD OF THE INVENTION

The present invention generally relates to the field of market analysis. In particular, the present invention is directed to an apparatus and a method for the generation of unique service data.

### BACKGROUND

Automated generation and improvement of unique service data has long been a labor intensive and inaccurate process. Current attempts at automating this process have failed to accurately identify consumer preferences, market share, and profitability of entities as it relates to the sale of goods and services. The demand of the markets and alter the unique service data according to that demand due. The failure has largely been attributed to a large number of variables involved while calculating the unique service data.

### SUMMARY OF THE DISCLOSURE

In an aspect, an apparatus for the generation of unique service data is disclosed. The apparatus includes at least a processor and a memory communicatively connected to the at least a processor. The memory instructs the processor to receive a plurality of user data and a plurality of entity data. The memory instructs the processor to identify one or more user clusters as a function of the user data, wherein identifying the one or more user clusters as a function of the user data comprises extracting a user keyword set from each of the one or more user clusters. The memory instructs the processor to identify one or more entity clusters as a function of the entity data, wherein identifying the one or more entity clusters as a function of the entity data comprises extracting an entity keyword set from each of the one or more entity clusters. The memory instructs the processor to generate unique service data as a function of the comparison of the one or more user clusters to the one or more entity clusters using a trained service machine learning model. Generating the unique service data includes iteratively training a service machine learning model using service training data, wherein the service training data comprises user keyword sets and entity keyword sets as inputs correlated to examples of unique service data as outputs. The memory instructs the processor to display the unique service data using a display device.

In another aspect, a method for the generation of unique service data is disclosed. The method includes receiving, by at least a processor, a plurality of user data. The method includes receiving, by the at least a processor, a plurality of entity data. The method includes identifying, by the at least a processor, one or more user clusters as a function of the user data, wherein identifying the one or more user clusters as a function of the user data comprises extracting a user keyword set from each of the one or more user clusters. The method includes identifying, by the at least a processor, one or more entity clusters as a function of the entity data, wherein identifying the one or more entity clusters as a function of the entity data comprises extracting an entity keyword set from each of the one or more entity clusters. The method includes generating, by the at least a processor, unique service data as a function of the comparison of the one or more user clusters to the one or more entity cluster. Generating the unique service data includes iteratively training a service machine learning model using service training data, wherein the service training data comprises user keyword sets and entity keyword sets as inputs correlated to examples of unique service data as outputs. The method includes displaying the unique service data using a display device.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for the generation of unique service data;

FIG. 2 is a block diagram of an exemplary machine-learning process;

FIG. 3 is a block diagram of an exemplary embodiment of a unique service database;

FIG. 4 is a diagram of an exemplary embodiment of a neural network;

FIG. 5 is a diagram of an exemplary embodiment of a node of a neural network;

FIG. 6 is an illustration of an exemplary embodiment of fuzzy set comparison;

FIG. 7 is an illustration of an exemplary embodiment of a chatbot;

FIG. 8 is an illustration of an exemplary embodiment of user interface;

FIG. 9 is a flow diagram of an exemplary method for the generation of unique service data; and

FIG. 10 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to an apparatus and a method for the generation of unique service data is disclosed. The apparatus includes at least a processor and a memory communicatively connected to the at least a processor. The memory instructs the processor to receive a plurality of user data and a plurality of entity data. The memory instructs the processor to identify one or more user clusters as a function of the user data, wherein identifying the one or more user clusters as a function of the user data comprises extracting a user keyword set from each of the one or more user clusters. The memory instructs the processor to identify one or more entity clusters as a function of the entity data, wherein identifying the one or more entity clusters as a function of the entity data comprises extracting an entity keyword set from each of the one or more entity clusters. The memory instructs the processor to generate unique service data as a function of the comparison of the one or more user clusters to the one or more entity clusters using a trained service machine learning model. Generating the unique service data includes iteratively training a service machine learning model using service training data, wherein the service training data comprises user keyword sets and entity keyword sets as inputs correlated to examples of unique service data as outputs. The memory instructs the processor to display the unique service data using a display device. Exemplary embodiments illustrating aspects of the present disclosure are described below in the context of several specific examples.

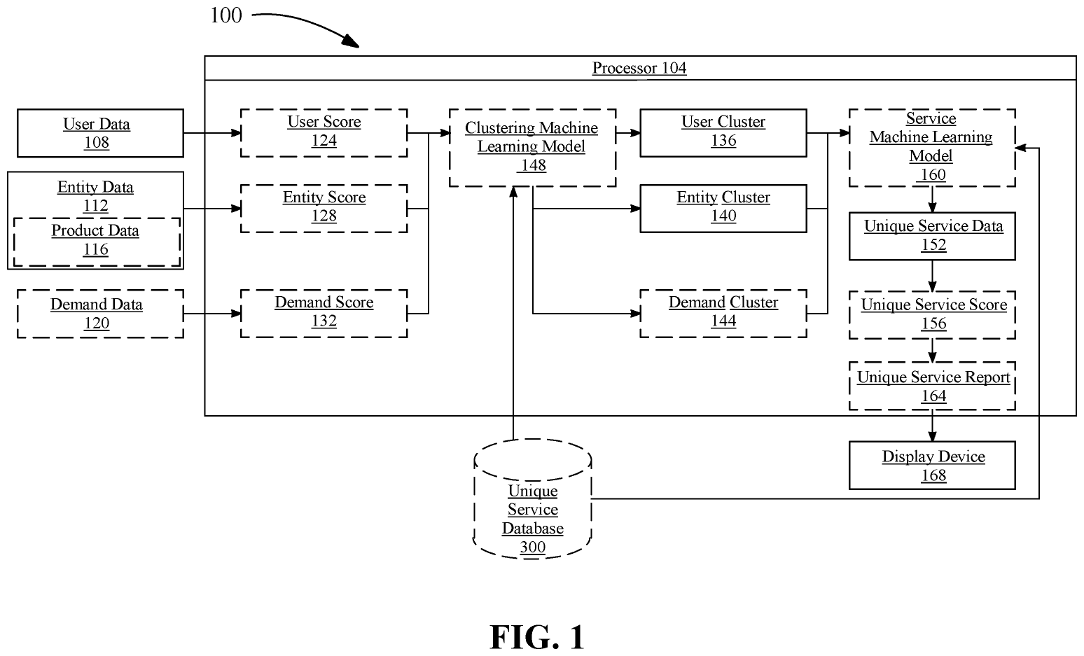

Referring now to FIG. 1, an exemplary embodiment of an apparatus 100 for the generation of unique service data is illustrated. Apparatus 100 includes a processor 104. Processor 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus, or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented using a “shared nothing” architecture in which data is cached at the worker, in an embodiment, this may enable scalability of apparatus 100 and/or computing device.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, apparatus 100 includes a memory. Memory is communicatively connected to processor 104. Memory may contain instructions configuring processor 104 to perform tasks disclosed in this disclosure. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, apparatus, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example, and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, without limitation, via a bus or other facility for intercommunication between elements of a computing device. Communicative connecting may also include indirect connections via, for example, and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, processor 104 receives a plurality of user data 108 from a plurality of users. As used in the current disclosure, “user data” is data associated with a user. User data 108 refers to information and statistics collected and analyzed about individuals or households for various purposes, typically related to their behavior, preferences, and interactions with products, services, and businesses. As used in the current disclosure, a “user” is a consumer of the entity. The user may include a manager, owner, or shareholder of the entity. User data may include information about past purchases, including what consumers bought, when they bought it, and how much they spent. This may include information related to the user's purchases across several locations within a predetermined time period. Additionally, User data 108 may include information associated with a user's online purchase history. This may include data on website visits, clicks, time spent on pages, and social media engagement. User data 108 may include demographic information about the consumer. This may include data about a consumer's age, gender, income, education, marital status, ethnicity, geographic location, socioeconomic status, and other basic characteristics. Demographic data helps companies create customer profiles and tailor their marketing strategies. User data 108 may include information regarding the consumer's behaviors. This may include information about a consumer's past and current behavior, such as purchase history, online activities, browsing patterns, and interaction with advertising and content. This data is crucial for understanding consumer preferences and predicting future behavior. User data 108 may include information related to the geographic data of the user. This category includes information about a consumer's past and current behavior, such as purchase history, online activities, browsing patterns, and interaction with advertising and content.

With continued reference to FIG. 1, processor 104 may be configured to receive an entity data 112 from a user. For the purposes of this disclosure, “entity data” is data associated with an entity. As used in the current disclosure, an “entity” is an organization comprised of one or more persons with a specific purpose. An entity may include a corporation, organization, business, group, and the like. Entity data 112 may be created by a processor 104, a user, or a third party. The entity data 112 may information regarding the entity's revenue, gross income, net income, business debts, a list of business expenses, current inventory, inventory history, sales information, human resource information, employee information, employee salaries, timecards, a list of company assets, a list of capital projects, accounting information, and the like. Entity data 112 may include information regarding the day-to-day activities of an entity. Entity data may include information about administrative tasks, operations and production, communications and collaborations, sales and marketing, financial management, customer service, human resources, information technology, research and development, and the like.

With continued reference to FIG. 1, entity data 112 may include product data 116. As used in the current disclosure, “product data” is data associated with the goods and services provided by the entity. Product data 116 may include a description of the goods and services that are provided by the entity. This may include information about the entity's products, including names, specifications, and features. Product data 116 may additionally include data associated with the cost to provide the goods and services. This may include the cost to the consumer and the cost to entity to provide the goods and services. Product data 116 may include information related to the inventory and/or capacity of the entity. This may include the current availability and stock levels of products. Alternatively, this may include capacity of the entity to provide services. Product data 116 may include a description of how the entity provides services to a consumer.

With continued reference to FIG. 1, product data 116 may include financial data. As used in the current disclosure, “financial data” refers to the monetary aspects and data related to the products or services offered by an entity. Financial data may include information for managing the financial aspects of a business and understanding the economic impact of the products or services in question. Financial data may include information about the initial price of a product or service, any discounts or promotional pricing, and any additional charges such as taxes or shipping fees. Accurate pricing data is essential for revenue calculation. Financial information may include data on the revenue generated from the sale of products. This can be broken down by product, product category, and over specific time periods. Financial data may include information related to cost of goods sold (COGS) as represents the direct costs associated with the production or procurement of the products. It includes expenses like raw materials, labor, and manufacturing costs. Understanding COGS is crucial for calculating gross profit. Financial data may include information about profit margins. Profit margins are calculated by subtracting the COGS from the revenue. This information helps assess the profitability of individual products and the business as a whole. Financial data may also include the valuation of the inventory, which is an asset on the balance sheet. Various methods like FIFO (First-In-First-Out) or LIFO (Last-In-First-Out) may be used to determine the value of inventory. If products are sold on credit, accounts receivable data is important. This represents the money owed to the business by customers who have yet to pay for their purchases. In addition to COGS, financial data may include information related to other operating expenses associated with selling the products, such as marketing, shipping, and overhead costs.

With continued reference to FIG. 1, entity data 108 may include a plurality of demand data 120. As used in the current disclosure, “demand data” is information regarding the market demand for the processes and procedures of the entity. Market demand may refer to total need within the market to accomplish a task or set of task using a process or procedure. It may represent the collective demand of all customers in the market for the goods and services. Additionally, demand data 120 may be calculated using sales data from the retailers and service providers who are present in the market. Demand data 120 may be calculated using several factors including the price range for goods and services, consumer preferences, target groups, target group budgets, consumer trends, market competition, market trends, and the like. Demand data 120 may include a description of the demand for goods and services within a geographic area. In an embodiment, demand data 120 may be described as a monetary value of the market. The monetary value of the market may be described as the sum of the value of the implementation of the processes or procedures across the market. This may include consulting costs, equipment costs, installation cost, employee training costs, and the like. These may be added up across the industry to provide the total monetary value of the market. Demand data 120 may include a prediction of the monetary value of the market at various time intervals. Determining the value of the market demand may involve assessing the market size, market growth, market growth rate, market growth potential, profit margins, and other relevant factors.

With continued reference to FIG. 1, Processor 104 may generate demand data 120 as a function of the market data. Processor 104 may collect relevant market data that provides insights into the demand drivers for the industry. Market data may include market research reports, industry surveys, government publications, trade associations' data, customer surveys, or any other reliable sources of information. This information may be gathered using a web crawler. In an embodiment, a web crawler may be configured to search a plurality of industry specific websites to gather market data. These websites may include government websites, accreditation body's websites, news websites, professional organizations websites, social media sites, and the like. The market data may additionally be generated by searching the websites of competitors within the industry. Market data may additionally be received from a database, wherein a database may include a plurality of industry specific market data. In some cases, processor 104 may use NLP models to identify market data from financial reports, stock markets forecasts, industry websites, governmental websites, and the like. Demand data 120 may include an analysis of economic indicators. This may include an analysis of macroeconomic indicators that can influence industry demand. Factors such as GDP growth, population trends, employment rates, inflation, consumer spending, and government policies can impact the overall demand for goods and services within an industry. In some embodiment, demand data 120 may include an analysis of the competitive landscape within a given industry. This may include an identification of the players within the market and their market share. This may include an identification and analysis of the market share and growth rates of key competitors, identify any emerging players or disruptive technologies, and consider the impact of industry-specific factors like barriers to entry, regulatory environment, and customer preferences.

With continued reference to FIG. 1, entity data 112, user data 108, and/or demand data 120 may be generated using tracking cookies. As used in the current disclosure, a “tracking cookie” is a small piece of data that a website sends to a user's web browser when they visit the site. These cookies are typically stored on the user's device, such as a computer or smartphone, and they serve various purposes, including tracking and collecting information about the user's online behavior.

In some embodiments, a cookies may be used generate the digital footprint of the consumer. The digital footprint of a consumer may then be used to generate entity data 112, user data 108, and/or demand data 120. Cookies may include small text files that websites and online services can place on a user's device to track their online activity. Cookies may work by sending a small amount of data from a website to a user's browser, which is then stored on the user's device. When the user visits the same website again, the browser sends the cookie data back to the website, allowing the website to remember the user's preferences and settings. There are two main types of cookies: session cookies and persistent cookies. Session cookies are temporary cookies that are deleted when the user closes their browser. Persistent cookies, on the other hand, remain on the user's device even after the browser is closed and can be used to remember the user's preferences for future visits to the website. While cookies can be useful for providing personalized experiences and improving website performance, they can also be used to track a user's digital footprint. By using cookies to track a user's online activity, processor 104 can build a detailed versions of entity data 112, user data 108, and/or demand data 120.

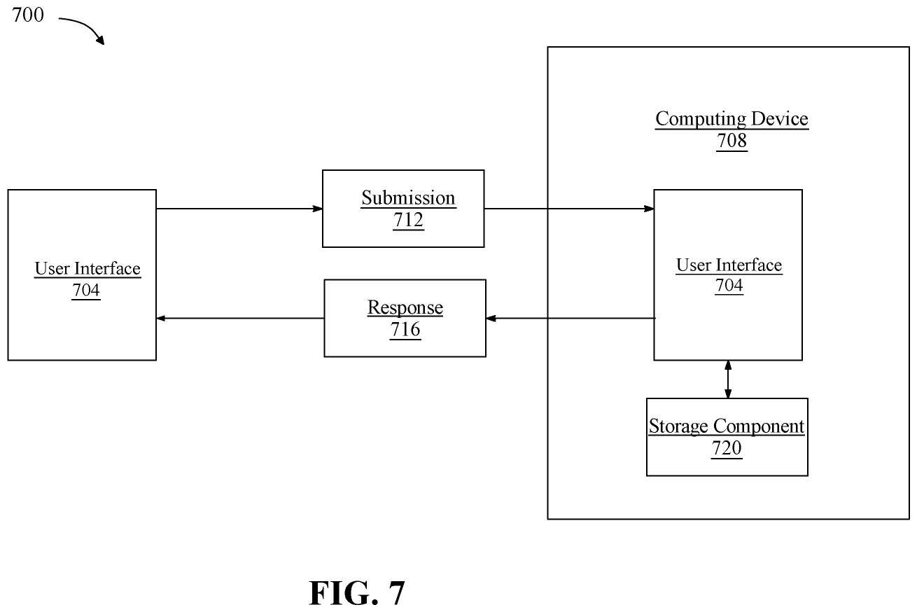

With continued reference to FIG. 1, entity data 112, user data 108, and/or demand data 120 may be received from a user and/or a consumer using a chatbot. A chatbot can be used to receive inputs from a user to generate user data, wherein a chatbot input is discussed in greater detail herein below. The chatbot may be configured to ask a user a plurality of inquiries related to one or more aspects of their consumerism. The chatbot may use natural language processing techniques to understand and extract key information from the user's responses. This may help in determining the specific attributes or characteristics of the user's purchase history from the entity. Based on the collected data and user inputs, the chatbot may generate a structured user data 108. Processor 104 may organize the information into different sections or categories based on the nature of the entity. This may be done using a chatbot as described herein below in FIG. 7.

With continued reference to FIG. 1, entity data 112, user data 108, and/or demand data 120 may be generated from one or more entity records. As used in the current disclosure, an “entity record” is a document that contains information regarding the entity. Entity records may include employee credentials, reports, financial records, medical records, business records, asset inventory, sales history, sales predictions, government records (i.e. birth certificates, social security cards, and the like), and the like. An entity record may additionally include operating records of the entity. Operating records may include things like data associated with the sales of goods and services by the entity. This may include things bills of sale, consumer records, sales projections, and the like. Entity records may be identified using a web crawler. Entity records may include a variety of types of “notes” entered over time by the entity, employees of the entity, support staff, advisors, consultants, tax professionals, financial professionals, and the like. Entity records may be converted into machine-encoded text using an optical character reader (OCR).

Still referring to FIG. 1, in some embodiments, optical character recognition or optical character reader (OCR) includes automatic conversion of images of written (e.g., typed, handwritten, or printed text) into machine-encoded text. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

Still referring to FIG. 1, in some cases, OCR may be an “offline” process, which analyses a static document or image frame. In some cases, handwriting movement analysis can be used as input for handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

Still referring to FIG. 1, in some cases, OCR processes may employ pre-processing of image components. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to the image component to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from the background of the image component. In some cases, binarization may be required for example if an employed OCR algorithm only works on binary images. In some cases, a line removal process may include the removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify a script allowing an appropriate OCR algorithm to be selected. In some cases, a character isolation or “segmentation” process may separate signal characters, for example, character-based OCR algorithms. In some cases, a normalization process may normalize the aspect ratio and/or scale of the image component.

Still referring to FIG. 1, in some embodiments, an OCR process will include an OCR algorithm. Exemplary OCR algorithms include matrix-matching process and/or feature extraction processes. Matrix matching may involve comparing an image to a stored glyph on a pixel-by-pixel basis. In some cases, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at the same scale as input glyph. Matrix matching may work best with typewritten text.

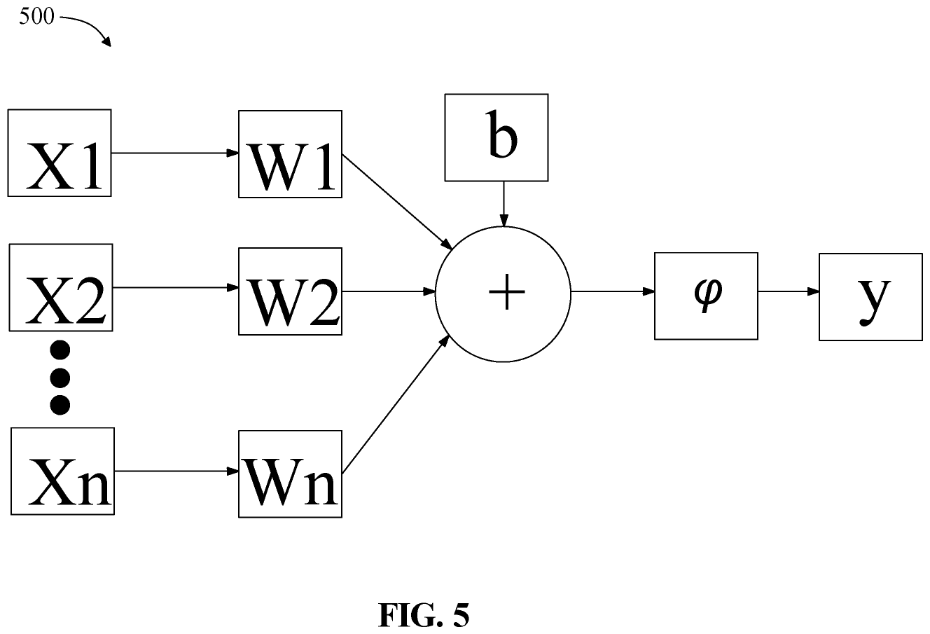

Still referring to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted features can be compared with an abstract vector-like representation of a character, which might reduce to one or more glyph prototypes. General techniques of feature detection in computer vision are applicable to this type of OCR. In some embodiments, machine-learning processes like nearest neighbor classifiers (e.g., k-nearest neighbors algorithm) can be used to compare image features with stored glyph features and choose a nearest match. OCR may employ any machine-learning process described in this disclosure, for example machine-learning processes described with reference to FIGS. 5-7. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

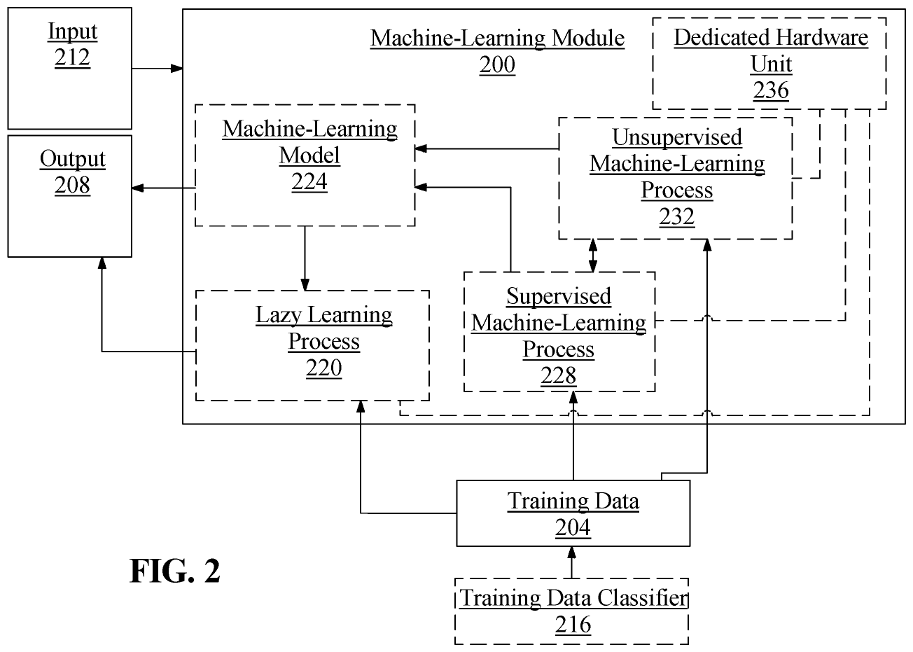

Still referring to FIG. 1, in some cases, OCR may employ a two-pass approach to character recognition. The second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool include OCRopus. OCRopus development is led by German Research Centre for Artificial Intelligence in Kaiserslautern, Germany. In some cases, OCR software may employ neural networks, for example neural networks as taught in reference to FIGS. 2, 4, and 5.

Still referring to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make use of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

With continued reference to FIG. 1, entity data 112, user data 108, and/or demand data 120 may be generated using a web crawler. A “web crawler,” as used herein, is a program that systematically browses the internet for the purpose of web indexing. The web crawler may be seeded with platform URLs, wherein the crawler may then visit the next related URL, retrieve the content, index the content, and/or measures the relevance of the content to the topic of interest. In some embodiments, processor 104 may generate a web crawler to compile the entity data 112 and entity data. The web crawler may be seeded and/or trained with a reputable website, such as the user's business website, to begin the search. A web crawler may be generated by a processor 104. In some embodiments, the web crawler may be trained with information received from a user through a user interface. In some embodiments, the web crawler may be configured to generate a web query. A web query may include search criteria received from a user. For example, a user may submit a plurality of websites for the web crawler to search to extract entity records, inventory records, financial records, human resource records, past entity profiles 108, sales records, user notes, and observations, based on criteria such as a time, location, and the like. In some cases, a web crawler may be seeded with the website to the entities website. The process of seeding a web crawler refers to the process of providing an initial set of URLs or starting points from which the crawler begins its exploration of the web. These initial URLs are often called seed URLs or a seed set. Seeding may be a curtail step in the web crawling process as it defines the starting point for discovering and indexing web pages.

With continued reference to FIG. 1, processor 104 may generate a user score 124 as a function of the user data 108. As used in the current disclosure, a “user score” is a numerical or quantitative measure that represents an individual's activity and engagement with products, services, or brands. This score may be generated by analyzing various aspects of a user's behavior and interactions, and it is used by businesses and organizations to assess and understand a user's consumption patterns. A user score 124 may be calculated based on the organization's goals and the specific metrics they consider important. This may include purchase frequency and amount, online activity, social media interactions, loyalty program participation, customer feedback and reviews, and the like. In an embodiment, a user score 124 may be calculated based upon the frequency and value of a user purchases. For example, users who make frequent and high-value purchases may receive higher user score 124. Additionally, a user score 124 may be calculated based on the engagement of the user on the company's website or app, such as browsing, clicking, and time spent. This may include a consideration of users who engage with the company on social media, such as liking, sharing, or commenting on posts, may receive higher scores. A processor 104 may generate a user score 124 for several markets or market segments. A user score 124 may be normalized. This may be done to bring all user scores 124 across all market segments onto a comparable scale. This step is important to eliminate any bias introduced by different units or measurement scales. Normalization techniques can include min-max scaling, z-score normalization, or logarithmic transformation. In an embodiment, if a user is a large consumer of goods/services a user score 124 may be high, conversely if a user has relatively low consumption of goods and services a user score 124 may be low. In an embodiment, a user score 124 may be expressed as a numerical score, a linguistic value, or an alphabetical score. A non-limiting example, of a numerical score, may include a scale from 1-10, 1-100, 1-1000, and the like, wherein a rating of 1 may represent a unactive consumer, whereas a rating of 10 may represent a highly active consumer. In another non-limiting example, linguistic values may include, “Strong Consumer,” “Moderate Consumer,” “Low Consumer,” and the like. In some embodiments, linguistic values may correspond to a linguistic variable score range. For example, a user that receives a score between 40-60, on a scale from 1-100, may be considered a “Moderate Consumer.”

With continued reference to FIG. 1, processor 104 may generate an entity score 128 as a function of the entity data 112. As used in the current disclosure, an “entity score” is a numerical or quantitative measure that represents the demand for one a good and service provided by an entity. An entity score 128 may additionally reflect the market share owned by each entity. This score may provide insight into the level of interest, popularity, or consumer engagement with the offerings of the entity. An entity score 128 may be used to assess how much interest or attention consumers have in the products or services offered by the entity. An entity score 128 may be determined based on sales and revenue, customer demand, website/app traffic and engagement, social media engagement, market research data, and the like. Entity data 128 may be normalized to ensure fair comparisons and assessments. Normalization can help account for variations in the size and scale of the entity, industry benchmarks, or other relevant factors. Normalization techniques can include min-max scaling, z-score normalization, or logarithmic transformation. In an embodiment, if a good/service sells at a high level an entity score 128 may be high, conversely if a good/service sells at a low level an entity score 128 may be low. In an embodiment, an entity score 124 may be expressed as a numerical score, a linguistic value, or an alphabetical score. A non-limiting example, of a numerical score, may include a scale from 1-10, 1-100, 1-1000, and the like, wherein a rating of 1 may represent a low level good/product, whereas a rating of 10 may represent a high level good or product. In another non-limiting example, linguistic values may include, “Strong Product,” “Moderate Product,” “Low Product,” and the like. In some embodiments, linguistic values may correspond to a linguistic variable score range. For example, a user that receives a score between 80-100, on a scale from 1-100, may be considered a “Strong Seller.”

With continued reference to FIG. 1, processor 104 may be configured to generate a demand score 132 as a function of the demand data 120 and/or entity data 108. As used in the current disclosure, a “demand score” is a score that describes the demand for goods and services in a given market. This may be calculated as a function of the demand data 120. A processor 104 may generate a demand score 132 for several markets or market segments. A demand score 132 may be normalized to bring all markets onto a comparable scale. This step is important to eliminate any bias introduced by different units or measurement scales. Normalization techniques can include min-max scaling, z-score normalization, or logarithmic transformation. In an embodiment, if a market possesses a particularly strong demand the demand score 132 may be high, conversely if a market possesses a particularly weak demand the demand score 132 may be low. A demand score 132 may be expressed as a numerical score, a linguistic value, or an alphabetical score. Demand score 132 may be represented as a score used to reflect the degree to which a market has a demand for the for the purchase of goods and services. A non-limiting example, of a numerical score, may include a scale from 1-10, 1-100, 1-1000, and the like, wherein a rating of 1 may represent an unfavorable market for the entity, whereas a rating of 10 may represent a highly favorable market for the entity. In another non-limiting example, linguistic values may include, “Strong Demand,” “Moderate Demand,” “Low Demand,” and the like. In some embodiments, linguistic values may correspond to a linguistic variable score range. For example, a market that receives a score between 40-60, on a scale from 1-100, may be considered a “Moderate Demand.”

With continued reference to FIG. 1, processor 104 may generate a user score, an entity score, and/or demand scores using a score machine-learning model. As used in the current disclosure, a “score machine-learning model” is a machine-learning model that is configured to generate a user score, an entity score, and/or a demand score. Score machine-learning model may be consistent with the machine-learning model described below in FIG. 2. Inputs to the score machine-learning model may include user data 108, entity data 112, product data 116, demand data 120, examples of user scores, examples of entity scores, examples of demand scores, and the like. Outputs to the score machine-learning model may include a user score, an entity score, and/or demand scores tailored to the user data 108, entity data 112, and/or demand data 120, respectively. Score training data may include a plurality of data entries containing a plurality of inputs that are correlated to a plurality of outputs for training a processor by a machine-learning process. In an embodiment, score training data may include a plurality of user data 108 correlated to examples of user scores. In an embodiment, score training data may include a plurality of entity data 112 correlated to examples of entity scores. In an embodiment, score training data may include a plurality of demand data 116 correlated to examples of demand scores. Score training data may be received from database 300. score training data may contain information about user data 108, entity data 112, product data 116, demand data 120, examples of user scores, examples of entity scores, examples of demand scores, and the like. In an embodiment, score training data may be iteratively updated as a function of the input and output results of past score machine-learning model or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model, and the like.

With continued reference to FIG. 1, processor 104 is configured to identify one or more clusters. As used herein, a “cluster” is a collection of data points representing the activities of the user and entity. A cluster may include a grouping of data points that represents a collection of similar or related data points within a dataset. In other words, a cluster may be a subset of data points that exhibit some degree of similarity or proximity to each other, while being distinct from other clusters in the dataset. Identification of clusters may be used to uncover patterns, structure, or relationships within a dataset such as user data 108 and/or entity data 116. Clusters can be formed based on various criteria, such as proximity in the feature space or similarity in demand. By identifying clusters, processor 104 may gain insights into the underlying structure of the data and potentially discover meaningful patterns or subgroups within user data 108 and/or entity data 116. In an embodiment, clusters may be generated as a function of the user score 124 and/or entity score 128 respectively. In an embodiment, a cluster may include a graphical representation of one or more user scores 124 and/or entity scores 128. This graphical representation may include one or more user scores 124 and/or entity scores 128 plotted as a single point or a plurality of points representing two or more user scores 124 and/or entity scores 128 over time. Processor 104 may identify one or more clusters based on their similarity or homogeneity as it relates to the group of data points. A cluster may represent groups of data points that share similar characteristics or properties. In some cases, a processor 104 may identify grouping and subgroupings based on the identification of one or more clusters. Clusters may indicate the existence of distinct subpopulations or classes within the dataset. Clusters can reveal patterns or structures in the data that are not immediately apparent. By examining the characteristics of data points within a cluster, we may uncover relationships or associations that can be useful for further analysis or decision-making. The term cluster as used through the entirety of this disclosure may refer to any of user clusters 136, entity clusters, 140, and/or demand clusters 144.

With continued reference to FIG. 1, a cluster may include plotting a user scores 124, demand scores 132, and/or entity scores 128 along a continuum. As used in the current disclosure, a “continuum” is a spectrum or a range of values, qualities, or attributes that exist along a single dimension or scale. A continuum may represent a continuous progression from one extreme to another, without any clear-cut boundaries or discrete categories. In a continuum, there are no distinct breakpoints or divisions, but instead, there is a gradual transition or progression from one end to the other. In some embodiments, a continuum may represent qualitative traits that exist on a spectrum. In a non-limiting example, a continuum may represent the degree of demand in a given market for one or more aspects of the process or procedures as reflected by one or more user scores 124, demand scores 132, and/or entity scores 128. A cluster may include a plurality of continuums, wherein each continuum represents one more trait or characteristic of an entity. In some embodiments, multiple continuums may be combined to generate an XY axis or an XYZ axis.

With continued reference to FIG. 1, processor 104 may extract a keyword set from each of the clusters mentioned herein. As used in the current disclosure, a “keyword set” is a collection of keywords or key phrases that are grouped together based on a specific theme, topic, or purpose. A keyword set that is extracted and clustered typically refers to a collection of keywords or key terms that have been grouped or organized into clusters based on their semantic or contextual similarities. This process is often used in various fields, including information retrieval, search engine optimization (SEO), data analysis, and natural language processing. The process may include the extraction of keywords from a given text, document, or dataset. This may include datasets such as entity data 112, user data 108, and/or demand data 120. Keywords are typically words or phrases that are considered significant in representing the content or themes of the text. These keywords may be identified through various techniques, such as natural language processing algorithms, statistical analysis, or manual selection. After extracting the keywords, they are grouped or clustered based on their similarities. Clustering is a technique used to organize data points (in this case, keywords) into groups or clusters so that keywords within the same cluster share common characteristics or themes. There are various clustering algorithms, such as K-means, hierarchical clustering, and DBSCAN, that can be employed to group keywords effectively. Keywords may be clustered based on their semantic or contextual similarity. This means that keywords with related meanings, topics, or concepts are grouped together. The clustering process aims to identify relationships and connections between keywords to help understand the underlying themes or topics within the text. Extracted and clustered keyword sets can be used in various applications. In a non-limiting example, within the context of data analysis keyword sets may be used to aid in identifying trends, patterns, or themes within a dataset.

With continued reference to FIG. 1, processor 104 is configured to identify one or more user clusters 136. As used in the current disclosure, a “user cluster” is a collection of data points associated with a user's consumption of goods and services. A user cluster 136 may be a dataset containing information about how users interact with and consume goods and services. It groups together individuals who exhibit similar patterns in their purchasing behavior. These patterns can include what they buy, how often they buy, when they buy, and various other related behaviors and preferences. A user cluster 136 may be a grouping of individuals who exhibit similar patterns in their purchasing behavior. A user cluster 136 may be generated using various data-driven techniques and algorithms, such as cluster analysis, machine learning, and data mining. User clusters 136 may be used to segment portions the consumer population into distinct groups to better understand their needs and tailor marketing strategies or product offerings to each cluster. These clusters may be created through the process of consumer segmentation, which is a fundamental concept in marketing and data analysis. User clusters 136 may provide insight into the consumerism of the user. A user cluster 136 may be used to describe in a graphical manner a group of consumers trends, behaviors, purchases, preferences, and the like. By examining the consumption patterns within each user cluster 136, processor 104 can gain a deeper understanding of the consumer behaviors that drive the purchasing of goods and services. This insight can inform decision-making, helping companies better meet consumer demands.

With continued reference to FIG. 1, identifying the one or more user clusters may include extracting a user keyword set from each of the one or more user clusters. As used in the current disclosure, a “user keyword set” is a collection of keywords or terms that are associated with and representative of the interests, behaviors, or preferences of the users within a particular cluster. These keyword sets are generated based on the data and characteristics of the users within the cluster, and they serve to summarize and categorize the key attributes of that group's consumption patterns. In some cases, user keyword sets may be generated through data analysis techniques, such as natural language processing (NLP), text mining, or content analysis. These techniques identify and extract relevant keywords from various data sources, such as user reviews, social media posts, purchase histories, and other user-generated content. The keywords in a user keyword set may be representative of the topics, products, or services that are of particular interest to the users in the cluster. They may include product names, category terms, action verbs, or descriptive adjectives that capture the essence of the cluster's consumption habits. User keyword sets may be specific to each user cluster and reflect the distinct patterns and behaviors observed within that group. For example, if one cluster consists of users who are interested in “organic food,” the corresponding keyword set might include terms like “organic, natural, sustainable,” and related words that are characteristic of this cluster's interests.

With continued reference to FIG. 1, processor 104 is configured to identify one or more entity clusters 140. As used in the current disclosure, an “entity cluster” is a collection of data points associated with the sales goods and services of an entity. An entity clusters may be a dataset containing information about how the entity sells goods and services to the consumer. These data points are specifically associated with how a particular entity (such as a business or organization) sells goods and services to consumers. It's a way of organizing and categorizing information that is pertinent to the entity's commercial activities. The data points within an entity cluster 136 may represent an entity score 128. The size, position, density, and the like of the entity cluster 140 may be indicative of a wide range of information including product and service information, sales and transactions, marketing promotional, inventory, supply chain data, and the like. Specifically, entity clusters 140 may provide an indication of what products and services are the most desired by the consumers. Entity clusters 140 may also provide an indication of what products and services are profitable to the entity.

With continued reference to FIG. 1, identifying the one or more entity clusters may include extracting an entity keyword set from each of the one or more entity clusters. As used in the current disclosure, an “entity keyword set” is a collection of keywords or key terms generated based on the information contained within the entity clusters. These keywords are likely derived from the data points within the entity clusters and can be used to describe or categorize the goods and services sold by the entity. These keywords may be generated to represent and summarize the essential characteristics, features, and aspects of an entity's sales of goods and services. In an embodiment, The entity keyword set may be generated through data analysis and text mining techniques applied to the information within the entity clusters. These techniques may involve extracting relevant keywords or terms from various data sources, such as sales records, product descriptions, marketing materials, and other relevant data points within the entity clusters. The keywords in an entity keyword set may be representative of the key elements that define an entity's commercial activities. These may include product names, service descriptions, brand names, industry-specific terms, or other words that encapsulate the entity's offerings and operations. Entity keyword sets may be specific to each entity cluster, reflecting the unique attributes and focus of that cluster's sales activities. For example, if an entity cluster pertains to a fashion retailer, the keyword set might include terms like “clothing, fashion, apparel, trends,” and related words that are relevant to the entity's offerings.

With continued reference to FIG. 1, an identifying an entity cluster 140 may include identifying one or more demand clusters 144. As used herein, a “demand cluster” is a collection of data points representing the demand for the goods and services of the entity. An attribute may include any or all metric associated with the demand as described by demand data 120 across multiple markets. Examples of the attributes of demand may include common need, location, common entity size, technological need, and the like. Demand clusters 144 may include a single attribute of the demand of the markets, or they may include more than one attribute. Demand clusters 144 may include multiple related attributes. In a non-limiting example, demand clusters may include a plurality of data points representing demand score 132, wherein the demand score 132 may the level of demand for the goods and services of the entity. The data points within a demand cluster 144 may represent the demand for a given goods and services within one or more markets. In some cases, a demand cluster 144 may represent the market share that is held by each good or service. For example, the entity provides service A into a geographical market A. Consumers within geographical market A spend approximately ten million dollars per-year on services that are similar to service A. A demand cluster 144 may provide an indication of where consumers spend their money and what percentage of the market is held by the entity. In some cases, each data point may represent the demand for an aspect of goods and services within a given market. In some embodiments, a demand cluster 144 may represent a common level of demand for goods and services across one or more markets or target groups. Processor 104 may compare the demand clusters 144 of a first market to the market share of the entity or the national averages to determine the overall demand for the goods and services.

With continued reference to FIG. 1, identifying the one or more demand clusters may include extracting a demand keyword set from each of the one or more entity clusters. As used in the current disclosure, a “demand keyword set” is a collection of keywords or key terms derived from the information within the demand cluster. These keywords may be specifically chosen to represent and summarize the key attributes of the demand for an entity's goods and services across different markets and attributes. A demand keyword set may be generated through data analysis techniques, including natural language processing and text mining, applied to the information within the demand cluster. These techniques identify and extract relevant keywords from various data sources related to demand, such as market reports, consumer surveys, and demand-related documents. The keywords in a demand keyword set are chosen to represent the primary factors that influence the demand for the entity's goods and services. These may include market-specific terms, consumer needs, location-related keywords, industry-specific terms, or other relevant words that capture the essence of the demand. Demand keyword sets may be specific to the attributes of the demand within the demand cluster. For instance, if a demand cluster pertains to the demand for “sustainable clothing” in a specific geographic area, the keyword set might include terms like “sustainability, eco-friendly, ethical fashion,” and related words that are indicative of the demand in that market segment.

With continued reference to FIG. 1, processor 104 may identify user clusters 136, entity clusters 140, and/or demand clusters 144 using a clustering machine-learning model 148. As used in the current disclosure, a “clustering machine-learning model” is a machine-learning model that is configured to generate user clusters 136, entity clusters 140, and/or demand clusters 144. Clustering machine-learning model 148 may be consistent with the machine-learning model described below in FIG. 2. Inputs to the clustering machine-learning model 148 may include user data 108, entity data 112, product data 116, demand data 120, user scores 124, entity scores 128, demand scores 132 examples of user clusters 136, examples of entity clusters 140, examples of demand clusters 144, examples of user keyword sets, examples of entity keyword sets, examples of demand keyword sets, and the like. Outputs to the clustering machine-learning model 148 may include user clusters 136 tailored to the user scores 124. Outputs to the clustering machine learning model may include entity clusters 140 tailored to the entity scores 128. Outputs to the clustering machine learning model may also include demand clusters 144 tailored to the demand scores 132. The Clustering machine learning model 148 may assigns data points to clusters iteratively. Data points are typically assigned to the cluster with the nearest centroid or based on the specific algorithm's criteria. The process continues until some convergence criterion is met. Clustering training data may include a plurality of data entries containing a plurality of inputs that are correlated to a plurality of outputs for training a processor by a machine-learning process. In an embodiment, clustering training data may include a plurality of user scores 124 correlated to examples of user clusters 136. In an additional embodiment, clustering training data may include a plurality of entity scores 128 correlated to examples of entity clusters 140. In a third embodiment, clustering training data may include a plurality of demand scores 132 correlated to examples of demand clusters 144. Clustering training data may be received from database 300. clustering training data may contain information about user data 108, entity data 112, product data 116, demand data 120, user scores 124, entity scores 128, demand scores 132 examples of user clusters 136, examples of entity clusters 140, examples of demand clusters 144, examples of user keyword sets, examples of entity keyword sets, examples of demand keyword sets, and the like. In an embodiment, clustering training data may be iteratively updated as a function of the input and output results of past clustering machine-learning model 148 or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model, and the like.

With continued reference to FIG. 1, processor 104 may generate a keyword set using a keyword machine-learning model. As used in the current disclosure, a “keyword machine-learning model” is a machine-learning model that is configured to generate keyword set. This may include an entity keyword set, a user keyword set, and a demand keyword set. Keyword machine-learning model may be consistent with the machine-learning model described below in FIG. 2. Inputs to the keyword machine-learning model may include user data 108, entity data 112, product data 116, demand data 120, user scores 124, entity scores 128, demand scores 132 user clusters 136, entity clusters 140, demand clusters 144, examples of user keyword sets, examples of entity keyword sets, examples of demand keyword sets, and the like. Outputs to the keyword machine-learning model may include keyword sets tailored to the user clusters, entity cluster, and/or demand clusters. This may include an entity keyword set, a user keyword set, and a demand keyword set. This may include generating a user keyword set, entity keyword sets, and demand keyword sets as a function of each of their respective cluster. Keyword training data may include a plurality of data entries containing a plurality of inputs that are correlated to a plurality of outputs for training a processor by a machine-learning process. In an embodiment, keyword training data may include a plurality of user clusters 136 correlated to examples of user keyword sets. In an embodiment, keyword training data may include a plurality of entity clusters 136 correlated to examples of entity keyword sets. Keyword training data may be received from database 300. Keyword training data may contain information about user data 108, entity data 112, product data 116, demand data 120, user scores 124, entity scores 128, demand scores 132 examples of user clusters 136, examples of entity clusters 140, examples of demand clusters 144, examples of user keyword sets, examples of entity keyword sets, examples of demand keyword sets, and the like. In an embodiment, keyword training data may be iteratively updated as a function of the input and output results of past keyword machine-learning model or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model, and the like.

Still referring to FIG. 1, a clustering machine-learning model 148 may include unsupervised clustering algorithm. An unsupervised clustering algorithm is a machine learning technique used to group similar data points into clusters or categories without the need for prior labeling or supervision. Unlike supervised learning, where the algorithm is trained on labeled data, unsupervised clustering algorithms work with unlabeled data to discover patterns, structures, or natural groupings within the data. Unsupervised clustering does not rely on predefined labels or categories for the data. The algorithm autonomously determines which data points are similar and should belong to the same cluster based on the inherent characteristics of the data. Unsupervised clustering does not rely on predefined labels or categories for the data. The algorithm autonomously determines which data points are similar and should belong to the same cluster based on the inherent characteristics of the data. An unsupervised clustering algorithm may be the similar to the unsupervised machine learning algorithm discussed herein below in FIG. 2.

Still referring to FIG. 1, processor 104 may be configured to generate a machine-learning model, such as clustering machine-learning model 148, using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm l=\sqrt{Σᵢ₌₀ⁿaᵢ²}, where aᵢ is attribute number experience of the vector. Scaling and/or normalization may function to make vector comparison independent of absolute quantities of attributes, while preserving any dependency on the similarity of attributes; this may, for instance, be advantageous where cases represented in training data are represented by different quantities of samples, which may result in proportionally equivalent vectors with divergent values.

Continuing refer to FIG. 1, a clustering machine-learning model 148 may perform cluster analysis on each of the user clusters 136, entity clusters 140, and/or demand clusters 144. “Cluster analysis” as used in this disclosure, includes grouping a set of data points in way that data points in the same group or cluster are more similar to each other than to those in other groups or clusters. Cluster analysis may use a distance metric to create a user cluster 136 and/or entity clusters 140. A distance metric is used to measure the similarity or dissimilarity between data points. Common distance metrics include Euclidean distance, Manhattan distance, or cosine similarity. The choice of distance metric depends on the nature of the data and the specific goals of the analysis. Cluster analysis may be performed by various cluster models that include connectivity models such as hierarchical clustering, centroid models such as k-means, distribution models such as multivariate normal distribution, density models such as density-based spatial clustering of applications with nose (DBSCAN) and ordering points to identify the clustering structure (OPTICS), subspace models such as biclustering, group models, graph-based models such as a clique, signed graph models, neural models, and the like. Cluster analysis may include hard clustering whereby each observation or unclassified cluster data entry belongs to a cluster or not. Cluster analysis may include soft clustering or fuzzy clustering whereby each observation or unclassified cluster data entry belongs to each cluster to a certain degree such as for example a likelihood of belonging to a cluster; for instance, and without limitation, a fuzzy clustering algorithm may be used to identify clustering of gene combinations with multiple disease states, and vice versa. Cluster analysis may include strict partitioning clustering whereby each observation or unclassified cluster data entry belongs to exactly one cluster. Cluster analysis may include strict partitioning clustering with outliers whereby observations or unclassified cluster data entries may belong to no cluster and may be considered outliers. Cluster analysis may include overlapping clustering whereby observations or unclassified cluster data entries may belong to more than one cluster. Cluster analysis may include hierarchical clustering whereby observations or unclassified cluster data entries that belong to a child cluster also belong to a parent cluster.

With continued reference to FIG. 1, processor 104 may be further configured to compare an entity cluster 140 and/or user cluster 140 using a fuzzy matching process. As used in the current disclosure, a “fuzzy matching process” is a technique used in data analysis and information retrieval to compare and match strings or data points that are not an exact match but are similar or closely related. It is often used when dealing with data that may contain typos, abbreviations, variations in formatting, or minor differences. Processor 104 may first tokenize the keywords in each cluster. Tokenization involves breaking down the keyword sets into individual terms or tokens, which can be words or phrases. Processor 104 may be configured to choose a fuzzy matching algorithm or method based on your specific requirements and the level of similarity you want to detect. Fuzzy matching algorithms may include Levenshtein distance, Jaccard Similarity, Cosine Similarity, Soundex and Metaphone, and the like. Processor 104 may be configured to determine a similarity threshold that defines what level of similarity you consider as a match. The threshold can be set based on the application's requirements and the trade-off between precision and recall. A lower threshold will result in more lenient matches, while a higher threshold will require a stricter match. Processor 104 may apply the chosen fuzzy matching algorithm to compare the tokens in each cluster pair. Compute a similarity score for each pair of tokens. This score quantifies the degree of similarity between the tokens. Based on the similarity scores, group the tokens or keyword sets into clusters. Tokens with similarity scores above the defined threshold are considered as matched or belonging to the same cluster.

With continued reference to FIG. 1, processor 104 is configured to generate unique service data 152 as a function of the comparison of the one or more user clusters 136 to the one or more entity clusters 140. In some cases, unique service data 152 may be generated as a function of a comparison of each of the one or more user clusters 136, the one or more entity clusters 140, and the one or more demand clusters 144. As used in the current disclosure, a “unique service data” refers to information associated with a company's most highly regarded products and services. Unique service data 152 may be determined through a combination of sales/profits, consumer preference and interactions, market share, and the like. Unique service data 152 may be characterized by the distinctiveness, relevance, and the value each product and service holds for the business according to analytical data. Unique service data 152 may be directly relevant to the core activities and offerings of a business. It specifically pertains to the products and services that the company provides to its customers. In an embodiment, Unique service data 152 may highlight what sets a company's products and services apart from those of its competitors. It identifies the unique selling propositions that make the company's offerings distinct and valuable to customers. Unique service data 152 may include information related to the how each product or service the entity provides is valued among its customers. Conversely, unique service data 152 may include information related how product or service the entity provides benefits the entity. Unique service data 152 may include information related to the market share of each product or service.

With continued reference to FIG. 1, unique service data 152 may include feedback to a user associated with an entity. This may include instructions regarding the improvements related to the goods and services provided by the entity. This feedback may be directed at employees, stakeholders, management, and the like. Feedback may be generated as a function of the information generated from the plurality of clusters. For example, if the demand clusters 144 indicate that there is a high demand for a given good or service. Unique service data 152 may provide feedback to the entity to increase the availability of the goods and services. In an additional non-limiting example, if the location of the user clusters 136 indicate that users have unfavorable opinions the service the entity provides due to its quality or price. Unique service data 152 may provide feedback to the entity to modify the goods or services to be more in line with their consumers preferences.

With continued reference to FIG. 1, unique service data 152 may be generated as a function of a distance metric between two or more clusters. Generating unique service data 152 as a function of the distance metric between two clusters involves utilizing a distance metric to quantify the dissimilarity or similarity between two clusters of data. The goal is to create a set of unique service data 152 points that capture the distinguishing features or relationships between these clusters. Processor 104 may be configured to calculate the distance between the two clusters using a suitable distance metric. Common distance metrics include Euclidean distance, Manhattan distance, cosine similarity, or more advanced methods such as hierarchical clustering. The distance metric may provide insights into how different or similar the two clusters are. Unique service data 152 is generated by identifying features, patterns, or characteristics that contribute to the measured distance. These features can be both shared and distinguishing elements between the clusters. Unique service data 152 may involve quantifying the magnitude of difference or similarity between the clusters based on the distance metric. This quantification can be represented as numerical values that indicate the degree of uniqueness or commonality.

With continued reference to FIG. 1, unique service data 152 may be reflected as an unique service score 156. As used in the current disclosure, a “unique service score” is a metric or numerical value generated based on the unique service data to evaluate and quantify the performance, value, or quality of a company's most highly regarded products and services. It may serve as a way to condense and represent the unique service data 152 in a single, actionable figure. The unique service data 152, which includes information such as sales/profits, consumer preference, market share, and more, serves as the foundation for calculating the unique service score 156. These data points are considered and analyzed to assess the performance and significance of each factor. To create a balanced score, different factors from the unique service data may be given different weights. In an nonlimiting example, profit margins may be weighted more heavily than consumer reviews if financial performance is more critical to the entity's goals. In an additional example, if the entities goals include gaining market share, then market share may be weighted more heavily than the current profits. The market perspective factor within the in the unique service score 156 may take a consideration of factors like market share, competitiveness, and how well each product or service addresses market demand. Products or services that capture a significant market share and effectively meet market needs receive higher scores. The unique service score 156 may also assesses the value of products and services to the entity itself. This means the processor 104 may consider how each offering contributes to the entity's overall success, which can include factors like revenue generation, profit margins, and strategic importance to the business. In some embodiment, the score may also reflects the value of products and services from the perspective of consumers. This may involve consumer satisfaction, loyalty, and feedback. Positive consumer experiences and preferences can contribute to a higher score, indicating strong consumer value. A unique service score 156 may be normalized. This may be done to bring all unique service score 156 across all market segments onto a comparable scale. This step is important to eliminate any bias introduced by different units or measurement scales. Normalization techniques can include min-max scaling, z-score normalization, or logarithmic transformation. In an embodiment, a unique service score 156 may be expressed as a numerical score, a linguistic value, or an alphabetical score. A non-limiting example, of a numerical score, may include a scale from 1-10, 1-100, 1-1000, and the like, wherein a rating of 1 may represent a unactive consumer, whereas a rating of 10 may represent a highly active consumer. In another non-limiting example, linguistic values may include, “Highly Valuable Product,” “Average Value Product,” “Low Value Product,” and the like. In some embodiments, linguistic values may correspond to a linguistic variable score range. For example, a product or service that receives a score between 20-40, on a scale from 1-100, may be considered a “Low Value Product.”

With continued reference to FIG. 1, processor 104 may generate the unique service data 152 by comparing two or more clusters. In an embodiment, processor 104 may compare each of Comparing two or more clusters involves assessing the similarities, differences, and relationships between the data points or elements within those clusters. Clusters are groups of data points that share certain characteristics or features. In an embodiment, processor 104 may compare each of the clusters according to their Homogeneity, distinctiveness, compactness, connectedness, separation, centroids, size/density, shape, outlier, hierarchical structure, stability, and the like. In order to generate a meaningful comparison between each of the two or more cluster the data points within each cluster may be normalized or standardized to ensure that it's on a consistent scale. This is crucial for meaningful comparisons, as different data sources might have different units and ranges. In some cases, processor 104 may identify the centroids of each cluster. In some clustering methods, like k-means, clusters have centroids, which are the center points of the clusters. Processor 104 may compare clusters by measuring the distance between their centroids. Smaller distances may indicate clusters that are more similar, whereas larger distance may indicate that clusters are more dissimilar. In some cases, the two or more clusters may be compared using a silhouette score. The silhouette score is a metric used to assess the quality of clustering. It measures how similar an object is to its own cluster compared to other clusters. A higher silhouette score may indicate that the clusters are well-separated and appropriate. In some cases, processor 104 may compare two or more cluster as a function of the cluster purity. Cluster purity is a measure of how well the data points within a cluster belong to the same class or category. It's often used in the context of classification tasks. Processor 104 may compare clusters by calculating the purity of each cluster. Higher purity suggests more homogeneity within the cluster. In some embodiments, Data visualization techniques can also be employed to compare clusters. For example, t-SNE (t-Distributed Stochastic Neighbor Embedding) and PCA (Principal Component Analysis) can be used to reduce dimensionality and visualize data clusters in a lower-dimensional space.

With continued reference to FIG. 1, processor 104 may be configured to generate a unique service list as a function of demand score, user score, and/or entity score. As used in the current disclosure, a “unique service list” is a curated list of the entity's services or products that is specifically tailored to align with the level of demand in various market segments. The unique service list may be generated by analyzing the demand scores associated with different goods and services offered by the entity. Demand scores indicate the popularity and desirability of these offerings in various markets. Services or products with higher demand scores are given priority and are included in the unique service list. These are the offerings that are in high demand and have the potential to capture a significant market share. In an embodiment, unique service list may include a ranked list of the services and products of the entity in order from the most in demand to the least in demand. This may include a listing of the most desired services and products from the entity. In some cases, a unique service list may include a sorting of the services and products that are provided by the entity. This may include sorting the services and products according to profitability, popularity, market share, desirability, and the like.

With continued reference to FIG. 1, processor 104 may generate unique service data 152 using a service machine-learning model 160. As used in the current disclosure, a “service machine-learning model” is a machine-learning model that is configured to generate unique service data 152. Service machine-learning model 160 may be consistent with the machine-learning model described below in FIG. 2. Inputs to the service machine-learning model 160 may include user data 108, entity data 112, product data 116, demand data 120, user scores 124, entity scores 128, demand scores 132, user clusters 136, entity clusters 140, demand clusters 144, user keyword sets, entity keyword sets, demand keyword sets, examples of unique service data 152, examples of unique service scores 156, and the like. Service training data may include user keyword sets and entity keyword sets as inputs correlated to examples of unique service data as output. Outputs to the service machine-learning model 160 may include unique service data 152 and/or unique service scores 156 tailored to the user clusters 136, entity clusters 140, and/or demand clusters 144. The service machine-learning model 160 may be configured to compare two or more of the above mentioned clusters. In some embodiments, once the unique service data 152 is created the processor 104 may then quantify the data with a unique service score 156. Service training data may include a plurality of data entries containing a plurality of inputs that are correlated to a plurality of outputs for training a processor by a machine-learning process. In an embodiment, service training data may include a plurality of user clusters 136, entity clusters 140, and/or demand clusters 144 correlated to examples of unique service data 152. In an additional embodiment, service training data may include unique service data 152 correlated to examples of unique service scores 156. In a third embodiment, service training data may include a user keyword sets, entity keyword sets, and/or demand keyword sets correlated to examples of unique service data 152. Service training data may be received from database 300. service training data may contain information about user data 108, entity data 112, product data 116, demand data 120, user scores 124, entity scores 128, demand scores 132, user clusters 136, entity clusters 140, demand clusters 144, examples of unique service data 152, user keyword sets, entity keyword sets, demand keyword sets examples of unique service scores 156, and the like. In an embodiment, service training data may be iteratively updated as a function of the input and output results of past service machine-learning model 160 or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model, and the like.

With continued reference to FIG. 1, machine learning plays a crucial role in enhancing the function of software for generating a service machine-learning model 160. This may include identifying patterns of within the user clusters 136, entity clusters 140, and/or demand clusters 144 that lead to changes in the capabilities and type of the service machine-learning model 160. By analyzing vast amounts of data related to the clusters, machine learning algorithms can identify patterns, correlations, and dependencies that contribute to a generating the service machine-learning model 160. These algorithms can extract valuable insights from various sources, including evaluations of market share, profitability, and customer satisfaction associated with the user clusters 136, entity clusters 140, and/or demand clusters 144. By applying machine learning techniques, the software can generate the service machine-learning model 160 extremely accurately. Machine learning models may enable the software to learn from past iterations of service machine-learning model 160 and iteratively improve its training data over time.

With continued reference to FIG. 1, processor 104 may be configured to update the training data of the service machine-learning model 160 using user inputs. A service machine-learning model 160 may use user input to update its training data, thereby improving its performance and accuracy. In embodiments, the service machine-learning model 160 may be iteratively updated using input and output results of past iterations of the service machine-learning model 160. The service machine-learning model 160 may then be iteratively retrained using the updated service training data. For instance, and without limitation, service machine-learning model 160 may be trained using a first training data from, for example, and without limitation, a user input or database. The service machine-learning model 160 may then be updated by using previous inputs and outputs from the service machine-learning model 160 as second training data to then train a second machine learning model. This process of updating the service machine-learning model 160 and its associated training data may be continuously done to create subsequent service machine-learning models 160 to improve the speed and accuracy of the service machine-learning model 160. When users interact with the software, their actions, preferences, and feedback provide valuable information that can be used to refine and enhance the model. This user input is collected and incorporated into the training data, allowing the machine learning model to learn from real-world interactions and adapt its predictions accordingly. By continually incorporating user input, the model becomes more responsive to user needs and preferences, capturing evolving trends and patterns. This iterative process of updating the training data with user input enables the machine learning model to deliver more personalized and relevant results, ultimately enhancing the overall user experience. The discussion within this paragraph may apply to both the service machine-learning model 160 or any other machine-learning model/classifier discussed herein.

Incorporating the user feedback may include updating the training data by removing or adding correlations of user data to a path or resources as indicated by the feedback. Any machine-learning model as described herein may have the training data updated based on such feedback or data gathered using a web crawler as described above. For example, correlations in training data may be based on outdated information wherein, a web crawler may update such correlations based on more recent resources and information.

With continued reference to FIG. 1, processor 104 may use user feedback to train the machine-learning models and/or classifiers described above. For example, machine-learning models and/or classifiers may be trained using past inputs and outputs of service machine-learning model 160. In some embodiments, if user feedback indicates that an output of machine-learning models and/or classifiers was “bad,” then that output and the corresponding input may be removed from training data used to train machine-learning models and/or classifiers, and/or may be replaced with a value entered by, e.g., another value that represents an ideal output given the input the machine learning model originally received, permitting use in retraining, and adding to training data; in either case, classifier may be retrained with modified training data as described in further detail below. In some embodiments, training data of classifier may include user feedback.

With continued reference to FIG. 1, in some embodiments, an accuracy score may be calculated for the machine-learning model and/or classifier using user feedback. For the purposes of this disclosure, “accuracy score,” is a numerical value concerning the accuracy of a machine-learning model. For example, the accuracy/quality of the outputted service machine-learning model 160 may be averaged to determine an accuracy score. In some embodiments, an accuracy score may be determined for pairing of entities. Accuracy score or another score as described above may indicate a degree of retraining needed for a machine-learning model and/or classifier. Processor 104 may perform a larger number of retraining cycles for a higher number (or lower number, depending on a numerical interpretation used), and/or may collect more training data for such retraining. The discussion within this paragraph and the paragraphs preceding this paragraph may apply to both the service machine-learning model 160 or any other machine-learning model/classifier mentioned herein.

With continued reference to FIG. 1, processor 104 may identify a demand scope as a function of the unique service data 152. As used in the current disclosure, a “demand scope” is an identification of specific traits of the products and services that are in demand. Demand scope may additionally include an identification of segments of the market who have market demand for the process/procedure. Traits of the products/services within the demand scope may include traits such as price point, availability, durability, time saving, target audience appeal, consistency, financial savings, efficiency, energy efficiency, and the like. The market may be segmented in ways such as geography, demographics, customer behavior, or product/service attributes. This segmentation helps understand the specific demand patterns within different market segments. Processor 104 may determine the market scope based on the demand data 120 and/or demand clusters associated with the entity. More specifically, demand scope may be determined based on the industry of the entity.

With continued reference to FIG. 1, processor 104 may be configured to generate a unique service report 164 as a function of the unique service data 152. As used in the current disclosure, “unique service report” is a report containing details relating to unique service data 152. A unique service report is a document or presentation that is generated by a processor 104, and it serves to communicate and document the insights and details derived from unique service data 152. In an embodiment, a unique service report 164 may explain each aspect of the unique service data 152. A unique service report 164 may be created in the context of understanding and conveying the value and significance of the products and services provided by an entity. The report may contain a comprehensive overview of the unique service data 152, including the various aspects and dimensions that were analyzed to arrive at the conclusions. These aspects might include sales and profits, consumer preferences, market share, and other relevant factors. The unique service report may provide detailed insights into what each aspect of the unique service data 152 represents and why it is significant. For example, it may explain how consumer preferences were measured, how market share was determined, and how sales and profits were calculated. In some embodiments, a unique service report 164 may include visual aids such as charts, graphs, and tables to illustrate key points and trends. Visual representations make the data more accessible and easier to comprehend. Depending on the findings from the unique service data 152 analysis, the unique service report 164 may include recommendations for the entity. Generating a recommendation as a function of the unique service report involves leveraging the insights and information gathered from the report to provide tailored and valuable suggestions to consumers or decision-makers. Processor 104 may generate a tailored recommendation based on the user's or entity's preferences and the data from the unique service report. These recommendations may include specific services or products that are likely to be of interest or value. These recommendations may pertain to strategic decisions, product or service improvements, marketing strategies, resource allocation, and the like. Processor 104 may generate these recommendations using natural language processing models involve the analysis of large amounts of textual data to provide personalized suggestions or advice. These models employ techniques such as text mining, sentiment analysis, and deep learning to understand and interpret user preferences, historical behavior, and contextual information. They may then generate recommendations by comparing the unique service report 164 with a database of items or content, taking into account factors like relevance, popularity, and similarity to previous interactions. The resulting recommendations are typically conveyed in natural language, making them more accessible and engaging for the user. NLP models can be applied to various domains, including e-commerce, content curation, movie recommendations, and more, enhancing the user experience by delivering tailored and meaningful suggestions. The recommendations may then be provided to the user via a notification. A user may be sent a notification via text messages, push notifications, email, traditional mail, and the like. In some cases, a unique service report may be produced periodically, especially when new data becomes available or when there are changes in the business environment. Regular updates ensure that the entity remains informed and adaptable.

With continued reference to FIG. 1, processor 104 may generate unique service report 164 using a report machine-learning model. As used in the current disclosure, a “report machine-learning model” is a machine-learning model that is configured to generate unique service report 164. report machine-learning model may be consistent with the machine-learning model described below in FIG. 2. Inputs to the report machine-learning model may include user data 108, entity data 112, product data 116, demand data 120, user scores 124, entity scores 128, demand scores 132, user clusters 136, entity clusters 140, demand clusters 144, unique service data 152, unique service scores 156, examples of unique service reports 164, and the like. Outputs to the report machine-learning model may include unique service report 164 tailored to the unique service data 152. Report training data may include a plurality of data entries containing a plurality of inputs that are correlated to a plurality of outputs for training a processor by a machine-learning process. In an embodiment, report training data may include a plurality of unique service data 152 correlated to examples of unique service report 164. Report training data may be received from database 300. report training data may contain information about user data 108, entity data 112, product data 116, demand data 120, user scores 124, entity scores 128, demand scores 132, user clusters 136, entity clusters 140, demand clusters 144, unique service data 152, unique service scores 156, examples of unique service reports 164, and the like. In an embodiment, report training data may be iteratively updated as a function of the input and output results of past report machine-learning model or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model, and the like.

Still referring to FIG. 1, processor 104 may be configured to display the unique service data 152 using a display device 168. As used in the current disclosure, a “display device” is a device that is used to display a plurality of data and other digital content. A display device 168 may include a user interface. A “user interface,” as used herein, is a means by which a user and a computer system interact; for example through the use of input devices and software. A user interface may include a graphical user interface (GUI), command line interface (CLI), menu-driven user interface, touch user interface, voice user interface (VUI), form-based user interface, any combination thereof, and the like. A user interface may include a smartphone, smart tablet, desktop, or laptop operated by the user. In an embodiment, the user interface may include a graphical user interface. A “graphical user interface (GUI),” as used herein, is a graphical form of user interface that allows users to interact with electronic devices. In some embodiments, GUI may include icons, menus, other visual indicators, or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pulldown menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access. Information contained in user interface may be directly influenced using graphical control elements such as widgets. A “widget,” as used herein, is a user control element that allows a user to control and change the appearance of elements in the user interface. In this context a widget may refer to a generic GUI element such as a check box, button, or scroll bar to an instance of that element, or to a customized collection of such elements used for a specific function or application (such as a dialog box for users to customize their computer screen appearances). User interface controls may include software components that a user interacts with through direct manipulation to read or edit information displayed through user interface. Widgets may be used to display lists of related items, navigate the system using links, tabs, and manipulate data using check boxes, radio boxes, and the like.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example, one or more user clusters and one or more entity clusters as inputs correlated to unique service data 152 as outputs.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to specific clusters of demand data related to the market share of a product or service of the entity.

With further reference to FIG. 2, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may identified as having poor quality data, where “poor quality” is defined as having a signal to noise ratio below a threshold value.

As a non-limiting example, and with further reference to FIG. 2, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity, and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 136. Processor may interpolate the low pixel count image to convert the 100 pixels into 136 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 136. Processor may down-sample the high pixel count image to convert the 256 pixels into 136 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include entity clusters and user clusters as described above as inputs, unique service data 152 as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 232 may not require a response variable; unsupervised processes 232 may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized, or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

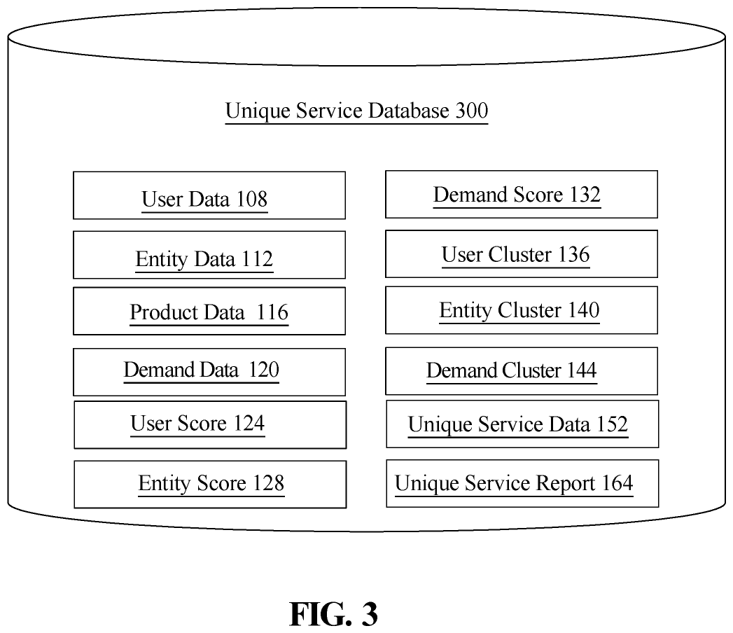

Now referring to FIG. 3, an exemplary unique service database 300 is illustrated by way of block diagram. In an embodiment, any past or present versions of any data disclosed herein may be stored within the unique service database 300 including but not limited to: user data 108, entity data 112, product data 116, demand data 120, user scores 124, entity scores 128, demand scores 132, user clusters 136, entity clusters 140, demand clusters 144, unique service data 152, unique service scores 156, unique service reports 164, and the like. Processor 104 may be communicatively connected with unique service database 300. For example, in some cases, database 300 may be local to processor 104. Alternatively or additionally, in some cases, database 300 may be remote to processor 104 and communicative with processor 104 by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure processor 104 connects directly, dynamically, and non-hierarchically to as many other computing devices as possible. A “network topology” as used in this disclosure is an arrangement of elements of a communication network. unique service database 300 may be implemented, without limitation, as a relational database, a key-value retrieval database such as a NOSQL database, or any other format or structure for use as a database that a person skilled in the art would recognize as suitable upon review of the entirety of this disclosure. unique service database 300 may alternatively or additionally be implemented using a distributed data storage protocol and/or data structure, such as a distributed hash table or the like. unique service database 300 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

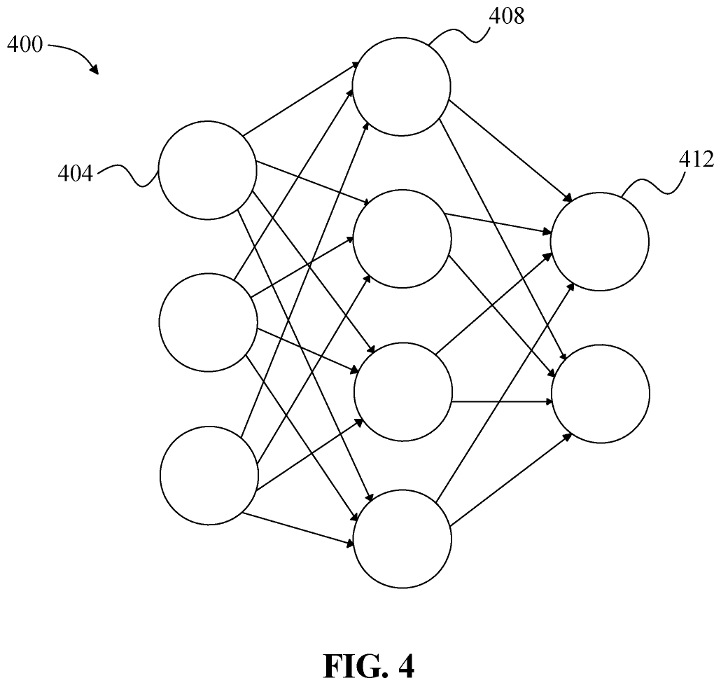

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

Referring now to FIG. 5, an exemplary embodiment of a node of a neural network is illustrated. A node may include, without limitation, a plurality of inputs xᵢ that may receive numerical values from inputs to a neural network containing the node and/or from other nodes. Node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

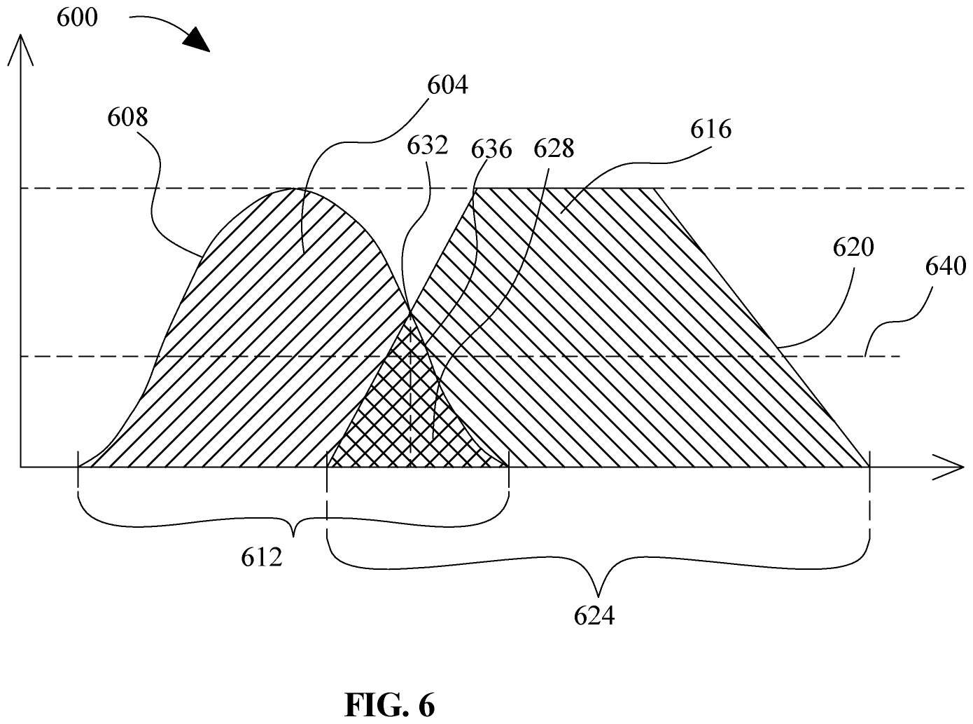

Now referring to FIG. 6, an exemplary embodiment of fuzzy set comparison 600 is illustrated. In a non-limiting embodiment, the fuzzy set comparison. In a non-limiting embodiment, fuzzy set comparison 600 may be consistent with fuzzy set comparison in FIG. 1. In another non-limiting the fuzzy set comparison 600 may be consistent with the name/version matching as described herein. For example and without limitation, the parameters, weights, and/or coefficients of the membership functions may be tuned using any machine-learning methods for the name/version matching as described herein. In another non-limiting embodiment, the fuzzy set may represent user clusters 136 and entity clusters 140 from FIG. 1.

Alternatively or additionally, and still referring to FIG. 6, fuzzy set comparison 600 may be generated as a function of determining the data compatibility threshold. The compatibility threshold may be determined by a computing device. In some embodiments, a computing device may use a logic comparison program, such as, but not limited to, a fuzzy logic model to determine the compatibility threshold and/or version authenticator. Each such compatibility threshold may be represented as a value for a posting variable representing the compatibility threshold, or in other words a fuzzy set as described above that corresponds to a degree of compatibility and/or allowability as calculated using any statistical, machine-learning, or other method that may occur to a person skilled in the art upon reviewing the entirety of this disclosure. In some embodiments, determining the compatibility threshold and/or version authenticator may include using a linear regression model. A linear regression model may include a machine learning model. A linear regression model may map statistics such as, but not limited to, frequency of the same range of version numbers, and the like, to the compatibility threshold and/or version authenticator. In some embodiments, determining the compatibility threshold of any posting may include using a classification model. A classification model may be configured to input collected data and cluster data to a centroid based on, but not limited to, frequency of appearance of the range of versioning numbers, linguistic indicators of compatibility and/or allowability, and the like. Centroids may include scores assigned to them such that the compatibility threshold may each be assigned a score. In some embodiments, a classification model may include a K-means clustering model. In some embodiments, a classification model may include a particle swarm optimization model. In some embodiments, determining a compatibility threshold may include using a fuzzy inference engine. A fuzzy inference engine may be configured to map one or more compatibility threshold using fuzzy logic. In some embodiments, a plurality of computing devices may be arranged by a logic comparison program into compatibility arrangements. A “compatibility arrangement” as used in this disclosure is any grouping of objects and/or data based on skill level and/or output score. Membership function coefficients and/or constants as described above may be tuned according to classification and/or clustering algorithms. For instance, and without limitation, a clustering algorithm may determine a Gaussian or other distribution of questions about a centroid corresponding to a given compatibility threshold and/or version authenticator, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Still referring to FIG. 6, inference engine may be implemented according to input user clusters 136 and entity clusters 140. For instance, an acceptance variable may represent a first measurable value pertaining to the classification of user clusters 136 to entity clusters 140. Continuing the example, an output variable may represent unique service data 152 associated with the user. In an embodiment, user clusters 136 and/or entity clusters 140 may be represented by their own fuzzy set. In other embodiments, the classification of the data into unique service data 152 may be represented as a function of the intersection two fuzzy sets as shown in FIG. 6, An inference engine may combine rules, such as any semantic versioning, semantic language, version ranges, and the like thereof. The degree to which a given input function membership matches a given rule may be determined by a triangular norm or “T-norm” of the rule or output function with the input function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max(a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively or additionally, output rules may be replaced with functions according to the Takagi-Sugeno-King (TSK) fuzzy model.

A first fuzzy set 604 may be represented, without limitation, according to a first membership function 608 representing a probability that an input falling on a first range of values 612 is a member of the first fuzzy set 604, where the first membership function 608 has values on a range of probabilities such as without limitation the interval [0,1], and an area beneath the first membership function 608 may represent a set of values within first fuzzy set 604. Although first range of values 612 is illustrated for clarity in this exemplary depiction as a range on a single number line or axis, first range of values 612 may be defined on two or more dimensions, representing, for instance, a Cartesian product between a plurality of ranges, curves, axes, spaces, dimensions, or the like. First membership function 608 may include any suitable function mapping first range 612 to a probability interval, including without limitation a triangular function defined by two linear elements such as line segments or planes that intersect at or below the top of the probability interval. As a non-limiting example, triangular membership function may be defined as:

$$( x , a , b , c ) = \{ \begin{matrix}\begin{matrix}0 , for x > c and x < a \\ \frac{x - a}{b - a} , for a \leq x < b\end{matrix} \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

First fuzzy set 604 may represent any value or combination of values as described above, including any user clusters 136 and entity clusters 140. A second fuzzy set 616, which may represent any value which may be represented by first fuzzy set 604, may be defined by a second membership function 620 on a second range 624; second range 624 may be identical and/or overlap with first range 612 and/or may be combined with first range via Cartesian product or the like to generate a mapping permitting evaluation overlap of first fuzzy set 604 and second fuzzy set 616. Where first fuzzy set 604 and second fuzzy set 616 have a region 636 that overlaps, first membership function 608 and second membership function 620 may intersect at a point 632 representing a probability, as defined on probability interval, of a match between first fuzzy set 604 and second fuzzy set 616. Alternatively or additionally, a single value of first and/or second fuzzy set may be located at a locus 636 on first range 612 and/or second range 624, where a probability of membership may be taken by evaluation of first membership function 608 and/or second membership function 620 at that range point. A probability at 628 and/or 632 may be compared to a threshold 640 to determine whether a positive match is indicated. Threshold 640 may, in a non-limiting example, represent a degree of match between first fuzzy set 604 and second fuzzy set 616, and/or single values therein with each other or with either set, which is sufficient for purposes of the matching process; for instance, the classification into one or more query categories may indicate a sufficient degree of overlap with fuzzy set representing user clusters 136 and entity clusters 140 for combination to occur as described above. Each threshold may be established by one or more user inputs. Alternatively or additionally, each threshold may be tuned by a machine-learning and/or statistical process, for instance and without limitation as described in further detail below.

In an embodiment, a degree of match between fuzzy sets may be used to rank one resource against another. For instance, if both user clusters 136 and entity clusters 140 have fuzzy sets, unique service data 152 may be generated by having a degree of overlap exceeding a predictive threshold, processor 104 may further rank the two resources by ranking a resource having a higher degree of match more highly than a resource having a lower degree of match. Where multiple fuzzy matches are performed, degrees of match for each respective fuzzy set may be computed and aggregated through, for instance, addition, averaging, or the like, to determine an overall degree of match, which may be used to rank resources; selection between two or more matching resources may be performed by selection of a highest-ranking resource, and/or multiple notifications may be presented to a user in order of ranking.

Referring to FIG. 7, a chatbot system 700 is schematically illustrated. According to some embodiments, a user interface 704 may be communicative with a computing device 708 that is configured to operate a chatbot. In some cases, user interface 704 may be local to computing device 708. Alternatively or additionally, in some cases, user interface 704 may remote to computing device 708 and communicative with the computing device 708, by way of one or more networks, such as without limitation the internet. Alternatively or additionally, user interface 704 may communicate with user device 708 using telephonic devices and networks, such as without limitation fax machines, short message service (SMS), or multimedia message service (MMS). Commonly, user interface 704 communicates with computing device 708 using text-based communication, for example without limitation using a character encoding protocol, such as American Standard for Information Interchange (ASCII). Typically, a user interface 704 conversationally interfaces a chatbot, by way of at least a submission 712, from the user interface 708 to the chatbot, and a response 716, from the chatbot to the user interface 704. In many cases, one or both of submission 712 and response 716 are text-based communication. Alternatively or additionally, in some cases, one or both of submission 712 and response 716 are audio-based communication.

Continuing in reference to FIG. 7, a submission 712 once received by computing device 708 operating a chatbot, may be processed by a processor. In some embodiments, processor processes a submission 712 using one or more of keyword recognition, pattern matching, and natural language processing. In some embodiments, processor employs real-time learning with evolutionary algorithms. In some cases, processor may retrieve a pre-prepared response from at least a storage component 720, based upon submission 712. Alternatively or additionally, in some embodiments, processor communicates a response 716 without first receiving a submission 712, thereby initiating conversation. In some cases, processor communicates an inquiry to user interface 704; and the processor is configured to process an answer to the inquiry in a following submission 712 from the user interface 704. In some cases, an answer to an inquiry present within a submission 712 from a user device 704 may be used by computing device 708 as an input to another function.

With continued reference to FIG. 7, A chatbot may be configured to provide a user with a plurality of options as an input into the chatbot. Chatbot entries may include multiple choice, short answer response, true or false responses, and the like. A user may decide on what type of chatbot entries are appropriate. In some embodiments, the chatbot may be configured to allow the user to input a freeform response into the chatbot. The chatbot may then use a decision tree, data base, or other data structure to respond to the users entry into the chatbot as a function of a chatbot input. As used in the current disclosure, “Chatbot input” is any response that a candidate or employer inputs in to a chatbot as a response to a prompt or question.

With continuing reference to FIG. 7, computing device 708 may be configured to the respond to a chatbot input using a decision tree. A “decision tree,” as used in this disclosure, is a data structure that represents and combines one or more determinations or other computations based on and/or concerning data provided thereto, as well as earlier such determinations or calculations, as nodes of a tree data structure where inputs of some nodes are connected to outputs of others. Decision tree may have at least a root node, or node that receives data input to the decision tree, corresponding to at least a candidate input into a chatbot. Decision tree has at least a terminal node, which may alternatively or additionally be referred to herein as a “leaf node,” corresponding to at least an exit indication; in other words, decision and/or determinations produced by decision tree may be output at the at least a terminal node. Decision tree may include one or more internal nodes, defined as nodes connecting outputs of root nodes to inputs of terminal nodes. Computing device 708 may generate two or more decision trees, which may overlap; for instance, a root node of one tree may connect to and/or receive output from one or more terminal nodes of another tree, intermediate nodes of one tree may be shared with another tree, or the like.

Still referring to FIG. 7, computing device 708 may build decision tree by following relational identification; for example, relational indication may specify that a first rule module receives an input from at least a second rule module and generates an output to at least a third rule module, and so forth, which may indicate to computing device 708 an in which such rule modules will be placed in decision tree. Building decision tree may include recursively performing mapping of execution results output by one tree and/or subtree to root nodes of another tree and/or subtree, for instance by using such execution results as execution parameters of a subtree. In this manner, computing device 708 may generate connections and/or combinations of one or more trees to one another to define overlaps and/or combinations into larger trees and/or combinations thereof. Such connections and/or combinations may be displayed by visual interface to user, for instance in first view, to enable viewing, editing, selection, and/or deletion by user; connections and/or combinations generated thereby may be highlighted, for instance using a different color, a label, and/or other form of emphasis aiding in identification by a user. In some embodiments, subtrees, previously constructed trees, and/or entire data structures may be represented and/or converted to rule modules, with graphical models representing them, and which may then be used in further iterations or steps of generation of decision tree and/or data structure. Alternatively or additionally subtrees, previously constructed trees, and/or entire data structures may be converted to APIs to interface with further iterations or steps of methods as described in this disclosure. As a further example, such subtrees, previously constructed trees, and/or entire data structures may become remote resources to which further iterations or steps of data structures and/or decision trees may transmit data and from which further iterations or steps of generation of data structure receive data, for instance as part of a decision in a given decision tree node.

Continuing to refer to FIG. 7, decision tree may incorporate one or more manually entered or otherwise provided decision criteria. Decision tree may incorporate one or more decision criteria using an application programmer interface (API). Decision tree may establish a link to a remote decision module, device, system, or the like. Decision tree may perform one or more database lookups and/or look-up table lookups. Decision tree may include at least a decision calculation module, which may be imported via an API, by incorporation of a program module in source code, executable, or other form, and/or linked to a given node by establishing a communication interface with one or more exterior processes, programs, systems, remote devices, or the like; for instance, where a user operating system has a previously existent calculation and/or decision engine configured to make a decision corresponding to a given node, for instance and without limitation using one or more elements of domain knowledge, by receiving an input and producing an output representing a decision, a node may be configured to provide data to the input and receive the output representing the decision, based upon which the node may perform its decision.

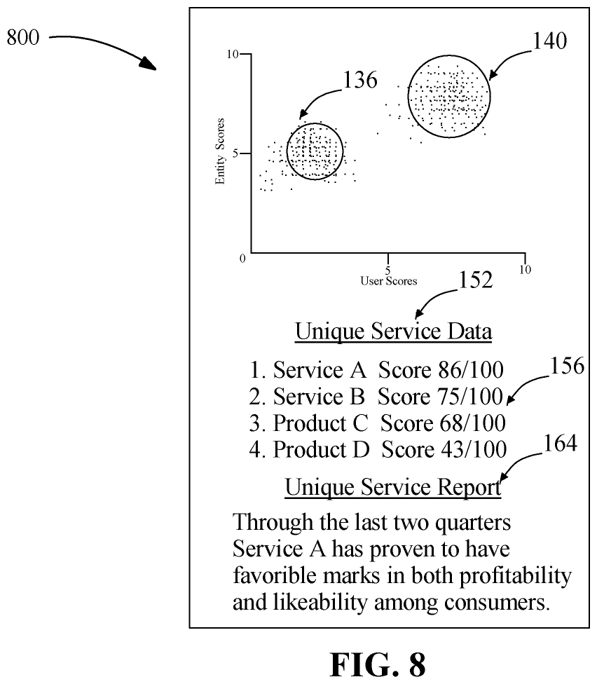

Referring now to FIG. 8, an exemplary embodiment of a user interface 800 is disclosed. The user interface 800 may show case both the unique service data 152 and the unique service report 164, providing a comprehensive overview of an entity's most valued goods and services. Users can access a visual representation of the unique service data 152 and a plurality of clusters including a user cluster 136 and an entity cluster 140, which includes essential insights about the demand, popularity, and profitability of the entity's offerings across different markets and attributes. This information is presented in an intuitive format, enabling users to quickly discern the key aspects that drive consumer preferences. Additionally, the user interface 800 displays the unique service report 164, offering a detailed analysis of the characteristics, behaviors, and patterns of these services. With clear visualizations and concise summaries, this interface empowers decision-makers to make informed choices, optimize resource allocation, and align their strategies with consumer demands and market dynamics.

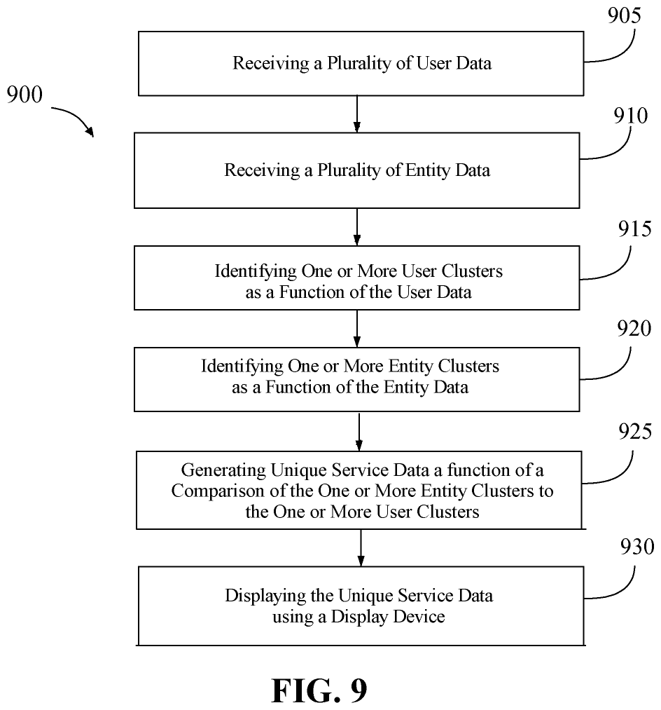

Referring now to FIG. 9, a flow diagram of an exemplary method 900 for the generation of unique service data is illustrated. At step 905, method 900 includes receiving, by at least a processor, a plurality of user data. This may be implemented as described and with reference to FIGS. 1-8. In an embodiment, receiving the plurality of user data may include receiving the plurality of user data from a user using a chatbot.

Still referring to FIG. 9, at step 910, method 900 includes receiving, by the at least a processor, a plurality of entity data. This may be implemented as described and with reference to FIGS. 1-8. In an embodiment, the plurality of entity data may include a plurality of product data.

Still referring to FIG. 9, at step 915, method 900 includes identifying, by the at least a processor, one or more user clusters as a function of the user data wherein identifying the one or more user clusters as a function of the user data comprises extracting a user keyword set from each of the one or more user clusters. This may be implemented as described and with reference to FIGS. 1-8.

Still referring to FIG. 9, at step 920, method 900 includes identifying, by the at least a processor, one or more entity clusters as a function of the entity data, wherein identifying the one or more entity clusters as a function of the entity data comprises extracting an entity keyword set from each of the one or more entity clusters. This may be implemented as described and with reference to FIGS. 1-8.

Still referring to FIG. 9, at step 925, method 900 includes generating, by the at least a processor, unique service data as a function of the comparison of the one or more user clusters to the one or more entity clusters. Generating the unique service data includes iteratively training a service machine learning model using service training data, wherein the service training data comprises one or more user cluster and one or more entity clusters as inputs correlated to examples of unique service data as outputs. This may be implemented as described and with reference to FIGS. 1-8. In an embodiment, the method may include generating, by the at least a processor, a user score as a function of the user data. In an embodiment, the method may include generating, by the at least a processor, an entity score as a function of the entity data. In some cases, generating the unique service data may include generating a unique service score. In an embodiment, method further includes generating, by the at least a processor, a unique service report as a function of the unique service data. In some cases, the method may include generating, by the at least a processor, a recommendation associated with the unique service report, wherein generating the recommendation may further include sending a notification to user.

Still referring to FIG. 9, at step 930, method 900 includes displaying the unique service data using a display device. This may be implemented as described and with reference to FIGS. 1-8.

Still referring to FIG. 9, the method may include receiving, by the at least a processor, a plurality of demand data. The method may also include identifying, by the at least a processor, one or more demand clusters as a function of the demand data. Additionally, the method may include generating the unique service data as a function a comparison between each of the one or more demand clusters, the one or more user clusters, and the one or more entity clusters. In some embodiments, the method may include generating, by the at least a processor, a demand scope as a function of the unique service data. The method may further include generating, by the at least a processor, a unique service list as a function of the demand score. In an embodiment, the method may further include calculating, using the at least a processor, a demand score for each entity cluster.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

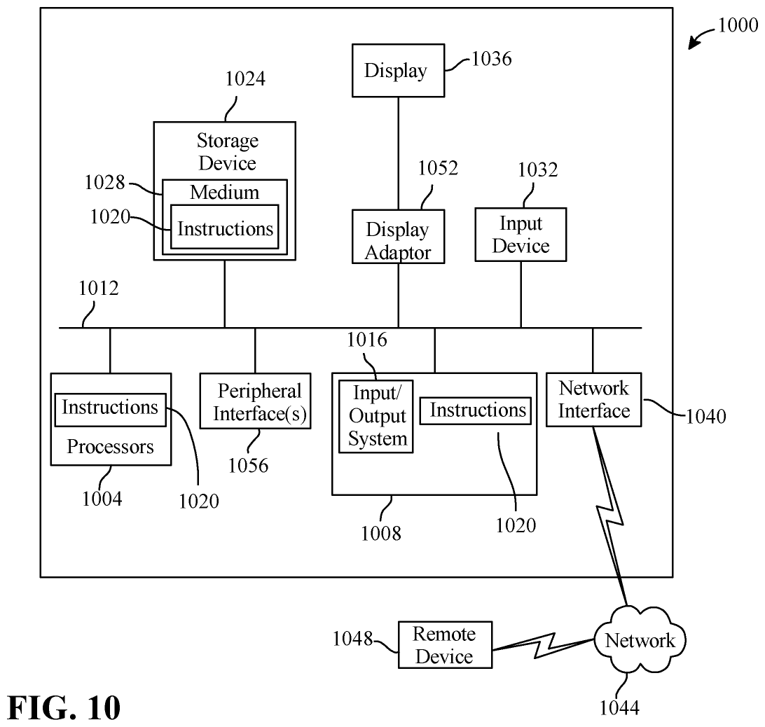

FIG. 10 shows a diagrammatic representation of one embodiment of a computing device in the exemplary form of a computer system 1000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1000 includes a processor 1004 and a memory 1008 that communicate with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Processor 1004 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1004 may be organized according to Von Neumann and/or Harvard architecture as a non-limiting example. Processor 1004 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 1008 may include various components (e.g., machine-readable media) including, but not limited to, a random-access memory component, a read only component, and any combinations thereof. In one example, a basic input/output system 1016 (BIOS), including basic routines that help to transfer information between elements within computer system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

Computer system 1000 may also include a storage device 1024. Examples of a storage device (e.g., storage device 1024) include, but are not limited to, a hard disk drive, a magnetic disk drive, an optical disc drive in combination with an optical medium, a solid-state memory device, and any combinations thereof. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with computer system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for computer system 1000. In one example, software 1020 may reside, completely or partially, within machine-readable medium 1028. In another example, software 1020 may reside, completely or partially, within processor 1004.

Computer system 1000 may also include an input device 1032. In one example, a user of computer system 1000 may enter commands and/or other information into computer system 1000 via input device 1032. Examples of an input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display 1036, discussed further below. Input device 1032 may be utilized as a user selection device for selecting one or more graphical representations in a graphical interface as described above.

A user may also input commands and/or other information to computer system 1000 via storage device 1024 (e.g., a removable disk drive, a flash drive, etc.) and/or network interface device 1040. A network interface device, such as network interface device 1040, may be utilized for connecting computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1044, may employ a wired and/or a wireless mode of communication. In general, any network topology may be used. Information (e.g., data, software 1020, etc.) may be communicated to and/or from computer system 1000 via network interface device 1040.

Computer system 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof. Display adapter 1052 and display device 1036 may be utilized in combination with processor 1004 to provide graphical representations of aspects of the present disclosure. In addition to a display device, computer system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

1. An apparatus for generating unique service data, wherein the apparatus comprises:
at least a processor; and
a memory communicatively connected to the at least a processor, wherein the memory contains instructions configuring the at least a processor to:
generate a plurality of user data;
receive a plurality of entity data;
receive score training data, wherein the score training data comprises entity data inputs correlated to entity score outputs;
sanitize the score training data using a dedicated hardware unit comprising circuitry configured to perform signal processing operations, wherein sanitizing the score training data comprises:
determining by the dedicated hardware unit that at least one training data entry of the score training data has a signal to noise ratio below a threshold value; and
removing the at least one training data entry from the score training data to create sanitized score training data;
train a score machine learning model as a function of the sanitized score training data;
generate an entity score as a function of the plurality of entity data using the trained score machine learning model trained;
identify one or more user clusters as a function of the user data and the entity score generated using the trained score machine learning model, wherein identifying the one or more user clusters as a function of the user data comprises extracting one or more user keyword sets from each of the one or more user clusters, wherein the one or more clusters comprises a graphical representation of the entity score generated using the trained score machine learning model;
identify one or more entity clusters as a function of the entity data, wherein identifying the one or more entity clusters as a function of the entity data comprises extracting one or more entity keyword sets of the one or more entity clusters;
generate unique service data as a function of a comparison of the one or more user clusters to the one or more entity clusters, wherein generating the unique service data utilizes a service machine learning model generated by creating an artificial neural network and comprises:
receiving a service training data set wherein the service training data set comprises the one or more user clusters, the one or more entity clusters, and the entity score generated by the trained score machine learning model as input correlated to examples of unique service data as an output;
iteratively updating the service machine learning model with past outputs of the unique service data and additional market feedback;
training the service machine learning model with the past outputs of the unique service data and the additional market feedback data as a function of operational parameters; and
outputting the unique service data using the trained service machine learning model, wherein the unique service data comprises a service score, wherein the service score integrates a product's value and consumer feedback; and
display the unique service data using a display device.

2. The apparatus of claim 1, wherein the memory further instructs the at least a processor to generate a user score as a function of the user data using the score machine learning model.

3. The apparatus of claim 1, wherein:
the plurality of entity data comprises demand data; and
the memory contains instructions further configuring the at least a processor to calculate a demand score for each entity cluster.

4. The apparatus of claim 3, wherein generating the unique service data comprises generating a unique service list as a function of the demand score.

5. The apparatus of claim 4, wherein the memory further instructs the at least a processor to generate a demand scope as a function of the unique service data.

6. The apparatus of claim 1, wherein the plurality of entity data comprises a plurality of product data.

7. (canceled)

8. The apparatus of claim 1, wherein the memory further instructs the at least a processor to generate a unique service report as a function of the unique service data.

9. The apparatus of claim 8, wherein the memory further instructs the at least a processor to generate a recommendation associated with the unique service report, wherein generating the recommendation further comprises sending a notification to a user.

10. The apparatus of claim 1, wherein receiving the plurality of user data comprises receiving the plurality of user data from a user using a chatbot.

11. A method for generating unique service data, wherein the method comprises:
receiving, by at least a processor, a plurality of user data;
receiving, by the at least a processor, a plurality of entity data;
receiving, by the at least a processor, score training data, wherein the score training data comprises entity data inputs correlated to entity score outputs;
sanitizing, by the at least a processor, the score training data using a dedicated hardware unit comprising circuitry configured to perform signal processing operations, wherein sanitizing the score training data comprises:
determining by the dedicated hardware unit that at least one training data entry of the score training data has a signal to noise ratio below a threshold value; and
removing the at least one training data entry from the score training data to create sanitized score training data;
training, by the at least a processor, a score machine learning model as a function of the sanitized score training data;
generating, by the at least a processor, an entity score as a function of the plurality of entity data using the trained score machine learning model;
identifying, by the at least a processor, one or more user clusters as a function of the user data and the entity score generated using the trained score machine learning model, wherein identifying the one or more user clusters as a function of the user data comprises extracting one or more user keyword sets from each of the one or more user clusters, wherein the one or more clusters comprises a graphical representation of the entity score generated using the trained score machine learning model;
identifying, by the at least a processor, one or more entity clusters as a function of the entity data, wherein identifying the one or more entity clusters as a function of the entity data comprises extracting one or more entity keyword sets from each of the one or more entity clusters;
generating, by the at least a processor, unique service data as a function of a comparison of the one or more user clusters to the one or more entity clusters, wherein generating the unique service data utilizes a service machine learning model generated by creating an artificial neural network and comprises:
receiving a service training data set, wherein the service training data set comprises the one or more user clusters, the one or more entity clusters, and the entity score generated by the trained score machine learning model as input correlated to examples of unique service data as an output;
iteratively updating the service machine learning model with past outputs of the unique service data and additional market feedback;
training the service machine learning model with the past outputs of the unique service data and the additional market feedback as a function of operational parameters; and
outputting the unique service data using the trained service machine learning model, wherein the unique service data comprises a service score, wherein the service score integrates a product's value and consumer feedback; and
displaying the unique service data using a display device.

12. The method of claim 11, wherein the method further comprises generating, by the at least a processor, a user score as a function of the user data using the score machine learning model.

13. The method of claim 11, wherein:
the plurality of entity data comprises demand data; and
the method further comprises calculating, using the at least a processor, a demand score for each entity cluster.

14. The method of claim 13, wherein the method further comprises generating, by the at least a processor, a unique service list as a function of the demand score.

15. The method of claim 14, wherein the method further comprises generating, by the at least a processor, a demand scope as a function of the unique service data.

16. The method of claim 11, wherein the plurality of entity data comprises a plurality of product data.

17. (canceled)

18. The method of claim 11, wherein the method further comprises generating, by the at least a processor, a unique service report as a function of the unique service data.

19. The method of claim 18, wherein the method further comprises generating, by the at least a processor, a recommendation associated with the unique service report, wherein generating the recommendation further comprises sending a notification to a user.

20. The method of claim 11, wherein receiving the plurality of user data comprises receiving the plurality of user data from a user using a chatbot.
